(19) United States
(12) Patent Application Publication
(10) Pub. No.: US 2006/0020431 A1
(43) Pub. Date: Jan. 26, 2006

(54) Path determination system for transport system

(76) Inventors: Peter Gipps, Heatherton (AU); Robert Nixon, Bonogin (AU); Alan Griffiths, Melbourne (AU)

Correspondence Address: STRATEGIC PATENTS P.C.., C/O PORTFOLIOIP, P.O. BOX 52050, MINNEAPOLIS, MN, 55402, US

(21) Appl. No.: 11/126,055

(22) Filed: May 10, 2005

Related U.S. Application Data
(63) Continuation-in-part of application No. 11/123,955, filed on May 6, 2005.
(60) Provisional application No. 60/569,897, filed on May 11, 2004.
(60) Provisional application No. 60/669,056, filed on Apr. 7, 2005.
(60) Provisional application No. 60/678,496, filed on May 5, 2005.

(51) Int. Cl. G06F 17/50

(52) U.S. Cl. 703/1

(57) ABSTRACT

Aspects of the present invention relate to path determination for transport system infrastructure paths. In embodiments, methods and systems are provided for identifying alternative paths and determining optimized transport system paths for projects. The methods and systems may involve providing a client-based application having a GUI that presents a plurality of constraints that relate to a project, a server-based application for calculating the costs of a plurality of potential paths for presenting a subset of paths with associated cost data, and determining optimized paths for at least one of a pipeline, a conveyor, a canal, a multipurpose utility pipe, and a telecommunication line.

### RELATED APPLICATIONS

This application claims the benefit of the following commonly owned U.S. provisional patent applications, each of which is incorporated herein by reference in its entirety: U.S. Prov. App. No. 60/569,897, filed May 11, 2004 and entitled “Methods and Systems for optimization of Corridors, Routes, Alignments and Paths for Linear Infratsructure”; U.S. Prov. App. No. 60/669,056, filed Apr. 7, 2005 and entitled “Methods and Systems for Optimization of Corridors, Routes Alignments, and Paths”; and Attorney Docket No. QNTM-0001-P60, filed May 5, 2005 and entitled “Terrain Design and Mapping Systems”.

This application is a continuation-in-part of commonly owned Attorney Docket No. QNTM-0002-P01, filed May 6, 2005 and entitled “Path Analysis System with Client and Server-Side Applications.” This application is incorporated by reference herein in its entirety.

This application is related to the following commonly owned, co-pending applications filed on even date herewith: Attorney Docket No. QNTM-0002-P02, entitled “Secure Infrastructure for Path Determination System”; Attorney Docket No. QNTM-0002-P03, entitled “User Interface for Path Determination System”; and Attorney Docket No. QNTM-0002-P04, entitled “Path Determination System for Vehicle Infrastructure Paths.” These applications are incorporated herein by reference in their entirety.

### BACKGROUND

1. Field

This invention relates to the field of determining a path, and more particularly, embodiments of the present invention relate to the field of optimizing corridors and alignments, routes, or paths.

2. Description of the Related Art

When planning and managing projects that involve the selection of paths, project teams must consider a wide range of constraints, including physical, geological, environmental, political, engineering, social, economic, and legal constraints. For some kinds of paths, such as infrastructure paths, they must also consider a range of cost factors that include unit costs for earthworks and structures, costs for site mitigation and additional costs that may be associated with clearing, and costs for acquisition or other factors such as landscaping or noise mitigation. Failing to account properly for a constraint can result in project delays, cost overruns, litigation, and a wide range of other problems.

Computer aided design (CAD) software currently exists to assist project teams in representing aspects of paths; however, the definition and selection of the path rely solely on the experience and judgment of the personnel responsible for the planning of the project. Determining the path is a trial and error iterative process that eventually arrives at a final path to be submitted for approval. This process can take a significant amount of time to create a center line for the path, calculate all of the costs associated with the path, and then review this information within the constraints of a budget. For example, the project teams must take into account the complete set of constraints that may influence the selection of a desired path. The costs associated with a selected path must be calculated by one or many different software products and then compiled into reports.

The process of manual selection of a path can only produce one path at a time, and the time and resource constraints of a project usually limit the number of path options to be considered.

Computer software programs exist for allowing project teams to automatically consider a wide range of potential paths, such as the offerings of Quantm.

CAD systems were fundamentally developed for project design (not planning) but are used by planners to ensure engineering constraints are met and to determine quantities (from which they could calculate costs). The path is determined manually by the planner, without optimization, and it does not support simultaneous consideration of engineering, cost, environmental, and social constraints.

GIS systems can be used to identify corridors by weighting the ‘non-cost’ factors, such as social and environmental constraints. To do this they weight environmental or socially sensitive zones with an arbitrary number, such as a number ranging from 1 to 5. The numbers for each zone crossed by a particular path are automatically added together, and the preferred path is the one that adds up to the lowest number. Some systems provide a “constructability index” that operates on a similar weighting basis but attempts to measure how to avoid areas in which construction would be difficult or costly. These approaches do not take into consideration the terrain, engineering constraints, geology, rules for crossing existing features, or costs and therefore cannot enable simultaneous consideration of cost, engineering, environmental, and social constraints.

A need exists for improved methods and systems for determining paths for a wide range of projects.

### SUMMARY

Aspects of the present invention relate to path determination for transport system infrastructure paths. The methods and systems may involve considering many aspects and constraints of an area around the transport system infrastructure path. The transport system infrastructure path determination may be for a pipeline, conveyor, canal, multipurpose utility pipe, power lines or telecommunication line.

Aspects of the present invention relate to the methods and systems for determining paths between points, such as paths for infrastructure (such as roads, railways, transportation canals, canals for hydroelectric plants, gas/liquid/slurry pipelines, conveyors, harbor channels, telecommunications lines, power lines, multipurpose utility pipes, and other construction infrastructure paths), paths for movement on a particular surface, paths for moving particular materials (such as glacial ice), or paths through a particular medium (such as mining for ore or crossing water).

The term ‘path’ as used herein is intended to refer to any path, route, alignment, corridor, infrastructure, civil engineering project, construction project, or other link for the purpose of movement between and among points, such as vehicular traffic (road and rail), movement of resources (pipelines, canals, conveyors, transmission lines), flow of matter, and the like, and any combinations of the foregoing, unless another specific meaning is indicated. A path may be linear, curved, continuous, discontinuous, or of any other configuration.

The terms ‘project team’ and ‘user’ are intended to refer to any project manager, planner, engineer, designer, consultant, agency, organization, or the like that is involved in the definitions of laws, approvals, constraints, costs, and other project data and may be responsible for input of data for, and/or review/approval of, paths.

Provided herein are methods and systems for providing paths based on user input of constraints and automatically generating a plurality of possible paths. Included are methods and systems for developing optimized paths that use software that can be delivered in a range of applications, including a client-based Graphical User Interface (GUI), a network facility, and a server-based application to provide a plurality of potential solutions for paths. The path may be roads, railways, transportation canals, canals for hydro-electric plants, gas/liquid/slurry pipelines, conveyors, harbor dredging, telecommunications lines, power lines, multipurpose utility pipes, or other such.

Although the client-based application and the server-based application are herein described in a client/server configuration, in an alternative embodiment both applications may be provided as part of a single integrated application, such as a shrink-wrapped software package, or as independent modules running on a single machine, rather than in the distributed architecture described herein. Accordingly, all embodiments described herein should be understood to allow implementation through a single application or single machine, notwithstanding the description of the client/server embodiment. In one embodiment the client-based GUI and server-based application may reside on the same computer and operate as a single product. In another embodiment the single application may be shrink-wrap packaged, provided by a consulting firm, or received by another method. The client or a consultant on the client computer system may install the single product. In the preferred embodiment the client-based application and the server-based application may reside on separate computer systems and may operate independently. The client-based application may be established on the client computer by Internet transfer of software, delivery of prepackaged software installed by the client, setup by a technical support person, or other method of computer software setup. The server-based application may be setup and maintained by a technical support person on an appropriate server and may be at a location separate from the client-based application. In other embodiments files may be interchanged between the client-based application and the server-based application by an Internet download, by email, by ftp, by direct connection, or other file transfer protocol. In another embodiment, in the absence of an Internet file transfer method, files may be exchanged by mass storage media such as CD, DVD, zip disk, hard drive, tape, or other mass storage media.

In an embodiment a project database may be created from terrain data and the client-based GUI may display the terrain data as colors to indicate altitude. To create the project database, terrain data in the form of a Digital Elevation Model (DEM) derived from satellite, aerial image data, or contour maps may be used. Additional digital data may be used to describe the locations of features, zones, constraints or boundaries. Such data may be imported in a range of formats such as DEM data, DXF data, ASCII data, GIS data, Genio data, or other data. Additional data relating to factors such as geology types, costs, crossing rules, noise zones, water currents, weather patterns, or line-of-sight may also be imported digitally or input manually. In an embodiment the terrain data may be created by an import tool as part of the client-based application. In an embodiment the user may select the import file type and the terrain file may be created on the client-based application. Once the project database is created it may be stored on the user's PC, if used as stand-alone software, or simultaneously stored in the server-based application and the client-based GUI if delivered in an application service provider format. In one embodiment, maintaining the project database in both the server-based application and the client-based GUI allows for small files to be transferred using the network notification method. In an embodiment the network notification method may be by direct file transmission or by email. This small file method of data transfer may result in faster data transfers.

In an embodiment, after the project data is stored on the server-based application and the client-based GUI, constraints may be defined using the client-based GUI. In an embodiment constraints may be graphically created on the client-based GUI and further define the area in which the project will be planned. Geotechnical zones indicating terrain substructure (such as soil and rock type), along with unit costs for extraction, batter slopes, and shoulder/benches associated with each geological strata type, may further define terrain. Compaction factors and percentage of a material that is reusable for fill once extracted may be defined. The geotechnical information may be used to define cost of material removal, whether it can be re-used on the project, and the cost of haulage during the construction phase. Linear features such as existing roads, rivers, and pipelines may be indicated, along with crossing rules that include height of clearance and structures, and may be considered while determining alternative paths. Multiple bridge and tunnel types, with associated characteristics and costs, may be defined for crossing of features and/or terrain. Portal costs for tunnel entrance and exits may be defined. Special zones may be defined that indicate zones to avoid, zones that require extra cost, zones that are to be ignored, or zones that have earthwork limits. Avoid zones may relate to avoidance by the alignment only, by the alignment and earthworks combined, or by the alignment, earthworks and an additional distance to enable construction vehicles to be used without impacting on the zone. Environmental zones may be defined as to be avoided, to be crossed within specified rules (such as structures), or to be used with the expectation of additional land cost for acquisition or mitigation. Geometric, or engineering, parameters may be defined such as minimum radius of curvature, maximum gradient, maximum sustained gradient, minimum gradient, formation width, combined or separate carriageways, median parameters, super-elevation/cant, and others. Locations and rules may be defined to consider earthmoving characteristics or limitations, including location of borrow pits or dump sites, requirements for extra cut or fill, or barriers to the movement of material (whether these are natural, such as rivers prior to bridge construction, or defined to limit distance of haulage.) Multiple geometric zones, each with its own parameters, may be created to reflect changes in carriageway type or width, passing lanes, entry and exit lanes, or varying design/engineering requirements to reflect speed changes, or rail or conveyor operating requirements. End points may be graphically defined to indicate the beginning and ending points of the desired path. Seed paths, guide alignments, guide points, or ‘attractors’ may be graphically created to focus the area of investigation for the path optimization. Seed paths or guide points are useful where there is a priori information as to a general location for the path. Pre-determined corridors can be defined using constraint zones to limit the area of investigation or ‘attractors’, which can be defined in three dimensions (xyz planes) and may force the paths to run through an area defined by the user. Minimum sight distance and horizontal and vertical coordination may be defined. The methods and systems disclosed herein will allow determination of a path that meets the defined constraints and the costs associated with earthworks and structures.

A number of features may be provided. In an embodiment data may be held in layers, which the user may define as active or inactive and make visible or invisible in the display. In an embodiment notes may be made in regard to data sets, scenarios, and results. These notes may be automatically date and time stamped for audit purposes. In an embodiment data may be stored as locked, whereby it cannot be altered, or unlocked. In an embodiment, “avoid zones” may include an avoidance priority level, such as high, medium, and low, or a numerical priority measure.

In an embodiment retaining walls may be input as forced (always inserted) in cut and/or fill, no retaining walls (never inserted) in cut and/or fill, or forced where earthworks exceed a height or depth limit defined by the user. In an embodiment culvert zones may be defined for crossing flood plains or areas that experience sheet water flows where a minimum number of culverts per distance may be required. In an embodiment curve compensation may be included in the consideration of path location for rail projects to reduce the limiting grades during horizontal curves. In an embodiment radius for vertical curves may be defined in k-values or in metric or imperial units.

In an embodiment a file management system may enable parameters to be simultaneously allocated or copied to multiple zones or features, such as rivers that need to be crossed using the same type of bridge or culverts.

In an embodiment earthwork volumes may be calculated with benches being automatically inserted, as defined by the user for each geology and strata, from the alignmerit, up or down, to the land surface. In an embodiment the volume of earthworks is calculated based on the shape of the land surface within the limits of the earthworks. Alternatively, the land surface may be calculated as a straight line between several points between the limits of the earthworks at the land surface.

Constraints may be defined for different types of projects or different aspects of a project. For example, constraints specific to pipeline planning may be defined, such as cross slope or long slope dependent costs, ability to and cost of ascending after ‘low points’, and necessity and parameters for pumping stations. Factors such as size of pipe, trenching costs, feature crossing costs, geology related time cost of construction, and extra costs relating to proximity, such as thicker walled pipe or corrosion protection, may be defined.

Constraints specific to canals may be defined, such as maximum or minimum allowable ‘head of water’, whether locations of locks or hydro power facilities are fixed or can be moved, and groundwater levels and lining cost impact of going through zones below groundwater level. Constraints specific to conveyors may be defined, such as varying geometry along their length, limitations of curve, grade, and crests and sags to maintain belt tension.

Constraints specific to telecommunication lines may be defined, such as cross slope or long slope dependent cost, line of sight, trench cost, zone crossing cost, and curvature. The telecommunication line may be a telephone line, DSL line, TV cable line, copper wire, coax cable, fiber optic line, microwave communication facilities, above ground cable, and below ground cable.

Planning a path may require input and feedback from environmental groups, consultants, contractors, suppliers, communities, municipalities, or other project related organizations during different stages of the planning. The client-based application may provide collaboration tools for these various groups to allow viewing and contribution to different stages of the planning. In an embodiment the client-based application may allow various security levels to be set that may have role-based permissions. In an embodiment the permissions may allow levels such as full modification of the project, cost-only editing, constraint-only editing, project reading only, report generating only, or other such levels of permission for the project. In an embodiment the permissions may be user definable to limit which aspects of the client-based application are accessible for which passwords or levels of permission. In an embodiment the client-based application may track paths created from different scenarios that may be viewed with descriptions of the latest revisions and may allow organizations to verify the constraints and the subsequent current path selection. In an embodiment a communication area may be provided where people of the different organizations may leave notes concerning the path and may view an archived knowledge base from previous path plans. In an embodiment the password capability may allow web based viewing tools such as PCAnywhere or VNC to be used to view the path options from remote locations. All capabilities available to a password level in the project office may be available remotely. The capability for organizations affected by the path to remotely view and comment on path options may be a key aspect for faster path planning. In embodiments the collaboration tools may be provided with version control facilities to allow users to manipulate a scenario (constraints, costs, or engineering parameters) version of a project while saving prior versions, to allow users to check out versions of a planning project, and the like. With the capability of constraint input and review by affected organizations, final approval of the planned path may be possible in less time and with reduced cost.

In an embodiment, completed project data, with constraints, may be transmitted from the client-based GUI to the server-based application using the network facility. The project database, incorporating the terrain data, digital constraint data, and all other data input by the user, is maintained simultaneously on both the client-based GUI and the server-based application so that files transmitted with data changes or identified paths can be limited to a small data file size.

In an embodiment after transmission of the constraint data from the client-based GUI to the server-based application, the data may be executed to create paths. Millions of possible paths may be generated on the server-based application to identify low cost options that meet the constraint requirements created on the client-based GUI. Of the total infrastructure paths generated, one or a number of paths may be provided by the server-based application which can be viewed by the user on the client-based GUI.

In an embodiment the user may indicate the type of optimization that is to be used by the server-based application. In one embodiment using an un-seeded optimization method, paths may be created based only on terrain and constraints. In another embodiment paths may be generated using several different seed paths. In an embodiment alternative paths may be generated from a highlighted linear feature such as an existing road or river, or from a manual path that has been created in a different software system and imported into the client-based GUI. In an embodiment a quick-seed path may be created by the user defining a series of generalized points in the form of an XYZ point string in an XYZ data file or by simply drawing a line in the GUI using mouse, keyboard, or other means of defining points that are linked to form a line that becomes the quick-seed and the basis of optimization to determine alignment alternatives. This is then used as the starting point/guide for generating alternative paths. In an embodiment paths may be generated using the total refinement method where the path may be close to a selected seed path which may have arisen from any of the methods described above. In an embodiment paths may be generated using the total intensive refinement method where the paths may be very close to a selected seed path. In an embodiment the paths may be generated using a vertical refinement method when the horizontal location of a path is fixed and only a vertical optimization may be performed. In an embodiment existing paths may be improved using local refinement when only certain local sections of a path may be refined on an otherwise acceptable path. In an embodiment using the local refinement method, a new local constraint may be added for consideration or avoidance with only those defined local sections being able to change, the rest of the alignment remaining fixed. In an embodiment the paths may be generated using realignment refinement for an upgrade of an existing path, whereby the new path will only depart from the existing path if it is required to do so to meet the user-defined constraints or engineering parameters, such as to allow for improved safety or increase of speed or traffic flow. The realignment may be set to reuse as much of the existing footprint to minimize amount of new land required, or may be set to reuse as much of the existing infrastructure as possible.

In an embodiment after the software or server-based application has selected a subset (where the number may be defined by the system or by user) of paths from the millions considered or generated, the subset of paths is transmitted to the client-based GUI. Once received at the client-based GUI each path may be reviewed. A plurality of paths may be viewed with the terrain and constraints on the client-based GUI and these can be color-coded based on a user defined ranking, such as cost, compliance with constraints, engineering standards, or other criteria. Each of the paths may be viewed in profile, and plan perspectives and multiple paths can be viewed simultaneously in plan and profile to allow comparison of costs, compliance with constraints, and quality of the engineering standards on the paths. Crossing types may be displayed on existing features such as rivers, roads, and railways. The extent of earthworks may be displayed with the physical extent of the regions of cut and fill shown horizontally and vertically, and bands may be used to represent benches, or steps, in the earthworks. Earthworks on the left and right banks of a path can be viewed in both plan and profile aspects. The locations of viaducts, tunnels, culverts, and bridge abutments may be displayed. The cross-section for each path can be viewed in user-defined locations along the path or can be viewed dynamically, during which the cross-section is shown in real time as the cursor is moved along the path. Cross section reports may provide edge of pavement, turning points of the earthworks, and the natural land surface for each selected path. Mass haul may be displayed to show the volumes and movement of spoil and useable material for the project.

In an embodiment a user may pan across the path displays in the GUI using a ‘click and grab’ approach. They may be able to zoom in on selected objects or by multiples of magnification. The zoom function may have a memory that allows the user to ‘undo’ or ‘redo’ recent views.

In an embodiment violations of constraints for any selected path may be listed in a report that displays existence, location, and extent of the violation.

In an embodiment a display window may display quantities and costs for earthworks, haulage, retaining walls, culverts, viaducts/bridges, tunnels, base and surfacing, ballast, pipes, etc. and display violation of user-defined constraints. The display window may show these costs for all displayed paths in a grid. Different paths may be highlighted in different colors to allow display of multiple paths for comparison purposes; these may demonstrate variances in paths and costs that result from factors such as inclusion/removal of new constraints, changes to engineering parameters, or changes to costs.

In an embodiment sections that represent drainage risks because of a low grade and proximity to ground level may be displayed

In an embodiment the paths may be developed using “what if” scenarios by revising constraints or revising the optimization seeding. In an embodiment, one path may be selected from an existing set of paths and may be used as a seed for further optimization runs with different parameters. This may yield a refined path. In an embodiment changes may be made and new files sent to the server-based application that may generate a different set of possible paths. The “what if” iteration process may uncover a path that may yield a lesser cost, more acceptable path, or other different path. In an embodiment the “what if” iteration may be performed to create paths that meet the engineering requirements as often as the user chooses. In an embodiment the iteration process may be completed significantly faster than traditional planning, and many different path possibilities may be reviewed in a short period of time. In an embodiment in reviewing all of the generated paths, one may be selected as the optimum path based on project requirements. The optimum path may be further refined to a final path by the server-based application to provide a final optimization in a narrow corridor.

In an embodiment, to further enhance visualization, actual aerial images, satellite images, contour maps, or other imagery may be used as background for the paths, and constraints may be viewed with any chosen background. A transparency function may allow such imagery to be draped over the digital terrain model with different levels of transparency to provide a 3-dimensional perspective to the images.

Reports for various aspects of the path may be generated to aid in the final path selection. In one embodiment a summary report may provide quantities and costs aggregated over an entire path. In one embodiment an interval report may provide quantities and costs broken down for integral parts of the path. In one embodiment a path report may provide X,Y,Z coordinates, distance, bearing, horizontal radius of curvature, grade, vertical radius of curvature, or other path information. In one embodiment a cross section report may be exported to a spreadsheet for cross section graphs of various locations of the path. In one embodiment an X,Y,Z Centerline report may provide a data file with X,Y,Z coordinates for an interval of the path. In an embodiment an environmental report may calculate fuel consumption and greenhouse gas emissions. In an embodiment a graphical interpretation of a noise model may be included in a report that includes alignments, constraints, and earthworks. This could be created either directly from the system or utilizing input data from noise modeling software.

In an embodiment the final path may be exported in a range of formats, such as ASCII strings, CSV strings with earthwork quantity/cost at user nominated interval, or as DXF/Shape strings that will allow it to be imported into CAD packages where the preliminary design for the project may be commenced.

In an embodiment files relating to the path and earthworks footprint can be exported in a variety of file or data formats (including CAD and GIS formats) for sharing between different users or applications.

As noted above, the system may enable varying levels of access for different parties. For example, one user may get access to input of all data and viewing of all paths and associated information, whereas another may not be able to input data and may only be able to view paths without volume, cost, or other data. In this way the process enables collaboration and involvement of multiple parties, such as consultants, stakeholders, and other interested environmental, heritage, and community groups. The process may also allow a project manager and a team to control data input and detail of information supplied. The varying levels of access may be controlled through codes, passwords, product keys, dongles, or other access limiting or controlling technology that may be developed.

In an embodiment comprehensive investigation of alternative scenarios can be undertaken, documented, and displayed to demonstrate consideration of numerous options and to present a rationale, based on social and environmental constraint compliance, engineering parameters, and cost. An iterative process enables effective analysis by adjusting one or multiple factors (input data) in each scenario submitted to the system for consideration. Resulting paths can then be compared to determine the implications to path, constraint compliance, and cost of each change.

In an embodiment outputs from the software, whether stand-alone or through a client-based GUI and server based application, may be input into other software to determine, for each path defined, what the implications of the optimized path may be for a range of factors such as whole-of-project cost, energy consumption and costs, user costs, traffic flows, travel time, noise mitigation, and others. Similarly, information from other software can be input in the form of changes to constraints, costs, or engineering parameters, such as additional land cost in areas where noise barriers will be required.

In an embodiment terrain data files, constraint data files, cost files, alignment files, and others may be encrypted prior to transfer between the client-based GUI and the server based application, or between the project team and the other parties that are allowed to input or view data, to provide a high level of security and protection of data.

In an embodiment a plurality of paths may be displayed, with groupings of low cost or constraint compliant paths indicating where potential corridors may be located.

In an embodiment the system may display wide bands that represent corridors where compliant paths can be located, rather than displaying specific paths. The corridor width may be defined by the user.

In an embodiment paths may be developed over long periods of time and constraints may be revised over time. In an embodiment during this development process, completely new paths may be explored based on changing requirements. In an embodiment after pursuing a different set of paths it may be decided to revisit a previous set of paths. In an embodiment previous paths may be stored in an historical file for future reuse. In an embodiment the historical data files may be maintained on data storage facilities associated with the client-based application or the server-based application as a hosted service. In an embodiment the historical data stored may be digital terrain models, constraints, costs, corridors, alignments, audit trail, or other files that define the project and may be recalled for use in the client-based application.

In many construction projects it may be required to maintain an audit trail of decisions made during the planning process and to track against requirements by affected organizations. In an embodiment the client-based application may have the capability to maintain an audit file to record significant decisions as they are made. In an embodiment an audit file option may be presented at the end of a planning sequence. In an embodiment the audit file option presented may be sensitive to modifications made to the project and may automatically open as a defined type of change is made. In an embodiment the audit file may maintain an automated or manual definition of the change made and may require a user description to be entered to document the modification. In another embodiment the client-based application may have an audit management tool that captures the project requirements based on affected organizations' requirements. In an embodiment the audit management tool may maintain any audit requirements and may be able to create reports to provide documentation as to complete and open aspects of the path selection process.

In an embodiment the audit management tool may require verification by the user that legislative requirements have been met, prior to allowing the file to be submitted.

In an embodiment an export tool may be available in the client-based application to export the final selected path to supported CAD and GIS software. In an embodiment the user may select the supported software for export and the drawing files for CAD software, or shape files for GIS software may be created automatically. Exporting drawing files to CAD software 25 may allow the construction design to begin in a short timeframe after the final path is selected.

### BRIEF DESCRIPTION OF THE FIGURES

FIG. 1 shows a block diagram of the communication method between a client-based GUI and a server-based application.

FIG. 2 shows the client-based GUI showing terrain.

FIG. 3 shows a block diagram of the communication methods of the terrain data to the server-based application and the client-based GUI, and locations for the project database that can be stored separately or stored on both the client-based GUI and the server-based application.

FIG. 4 shows the client-based GUI with various constraints defined.

FIG. 5 shows end points defined with guide points and an ‘attractor’.

FIG. 6 shows a block diagram of the client-based GUI sending constraint data to the server-based application and the server-based application sending paths.

FIG. 7 shows the client-based GUI with several of the paths displayed.

FIG. 8 shows the client-based GUI with a selected path simultaneously highlighted in the display and the legend.

FIG. 9 shows the client-based GUI with earthworks displayed and a summary table of quantities and costs associated with the selected path.

FIG. 10 shows the selected path in profile and plan view.

FIG. 11 shows the client-based GUI using an orthorectified image as the background, which can be derived from aerial, satellite, contour maps, or other imagery and can be input in a variety of formats.

FIG. 12 shows the client-based GUI with a popup image to provide a visual for a location.

FIG. 13 provides additional detail as to an architecture for a system for path optimization.

FIG. 14 shows the interaction of various constraints addressed simultaneously by a system of the present invention.

FIG. 14A shows an embodiment of path determination using safe distance zones for avoidance.

FIG. 14B shows an embodiment of path determination of minimum and maximum separation values.

FIG. 15 is a flow diagram showing an embodiment of a project flow employing the methods and systems described herein.

FIG. 16 shows a variety of environmental constraints addressed by a system of the present invention.

FIG. 17 shows embodiments of a single-machine implementation of the methods and systems described herein.

FIG. 18 shows an embodiment of a collaboration environment using methods and systems described herein.

FIG. 19 shows an embodiment where historical models are stored in association with a server application.

FIG. 20 shows a flow diagram for a project audit function/process, according to one embodiment of the invention.

FIG. 21 shows a flow diagram of an automated audit trail of revision decisions, according to one embodiment of the invention.

FIG. 22 shows a flow diagram for accessing encrypted data using an encryption key.

FIG. 23 shows a flow diagram of compliance requirement access to an application.

FIG. 24 shows an embodiment of land valuation based on path determination.

FIG. 25 shows an embodiment of user access to a user interactive window.

FIG. 26 shows an embodiment of path determination for non-land vehicles.

FIG. 27 shows an embodiment of real time path determination for terrain vehicles.

FIG. 28 shows an embodiment of path determination creation considering safe zones as defined from a distance and/or visual perspective.

FIG. 29 shows a flow diagram for the real time path determination for simulation applications.

FIG. 30 shows an embodiment of path determination training using a plurality of sources.

FIG. 31 shows an embodiment of a user accessing a path determination model remotely on a portable computer device.

FIG. 32 shows an embodiment of open mining ore.

FIG. 33 shows an embodiment of path determination of underground ore mining.

FIG. 34 shows an embodiment of fluid control over a terrain.

FIG. 35 shows an embodiment of path determination using digital terrain mapping.

FIG. 36 shows an embodiment of path determination in zones of ground water.

FIG. 37 shows a flow diagram of path determination value and ROI calculation.

FIG. 38 shows an embodiment of path determination for non-terrestrial locations.

FIG. 41 shows an embodiment of path determination of a conduit in a facility.

FIG. 42 shows an embodiment of path determination of a network in a facility.

FIG. 43 shows an embodiment of path determination for multi-vehicle pathways.

FIG. 44 shows an embodiment of path determination for iceberg farming.

FIG. 45 shows an embodiment of landfill location determination.

### DETAILED DESCRIPTION

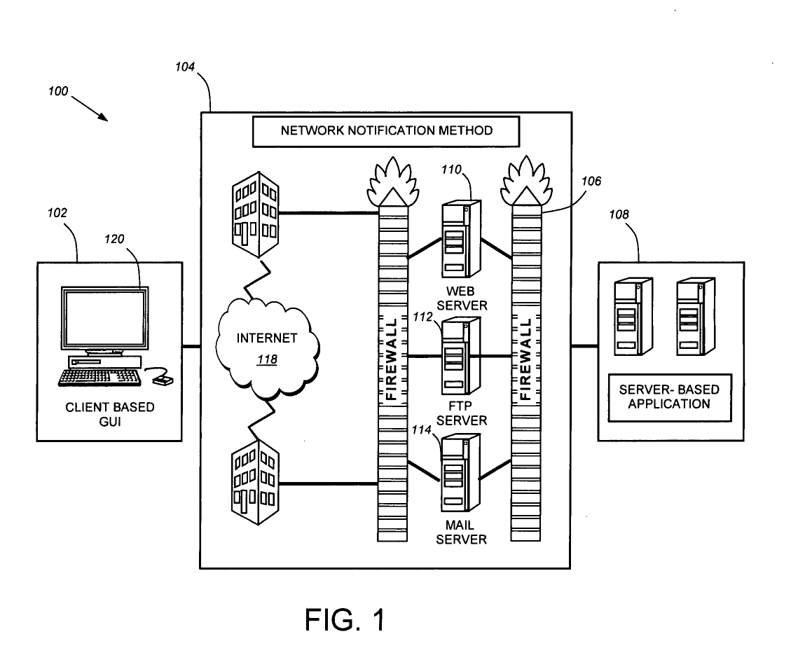

Referring to FIG. 1 a block diagram is shown of a system 100 for supporting the methods and systems described herein. The system 100 includes a client-based application 102 having a graphical user interface (GUI) 120 and a server-based application 108. The client-based application 102 with the GUI 120 is connected to the network facility 104. The network facility 104 may use or include any conventional network facility for transporting data, such as the Internet 118, a local area network, a wide area network, a router, a hub, an access point, a wireless network, a Bluetooth network, a cellular network, a DSL network, a cable network, or any other kind of network facility. The data can be sent via a web server 110, an FTP server 112, an HTTP server, a mail server 114, a firewall 106, or other form of server and system protection. The client-based application 102 connects to the server-based application 108 through the network facility 104. For example, the client-based application 102 with the GUI 120 and the server-based application may exchange files in a variety of methods such as email, ftp, direct connection file transfer, or other available file transfer methods. Further details of the client-based application 102 and the server-based application 108 are provided below.

The system depicted in FIG. 1 can be used as a path optimization software product that enables contingent path modeling incorporating the physical, environmental, and social constraints; cost; and engineering parameters and geology. The system utilizes data from geo-spatial imaging and softcopy photogrammetry, and path optimization allows users to develop and analyze detailed path models, while taking into account the many user-specific project constraints, natural constraints (i.e. topography), and social constraints (i.e. presence of towns). The result is a more accurate planning process that incorporates the factors that influence path selection and enables consideration of environmental and other constraints much earlier in the planning and selection process. The program can operate as software that can be installed on a stand-alone PC or in the format presented in the figure, which consists of two primary components: the client-based application 102, referred to herein in some cases as the integrator, and the server-based application 108, referred to herein in some cases as the pathfinder.

The system of FIG. 1 includes the front-end, client-based application 102, or integrator, that can reside on a client's computer, such as a personal computer. The integrator 102 allows paths to be viewed over digital terrain models (DTMs) and/or orthorectified images that can be derived from satellite images, aerial images, or contour maps. In embodiments, the DTM and other data is input into the server-based application 108, such as the pathfinder server 108. In embodiments the server-based application 108 then uses an optimization engine to evaluate millions of potential path options and produces path options that best match the user-defined path constraints. This output is forwarded back to the client over the network facility 104 and may be viewed with the client-based application GUI 120. The server-based application 108 can operate on a distributed system consisting of a server and a cluster of personal computers to enable parallel processing of output from the client-based application 102.

In embodiments the client-based application 102 may include a range of capabilities, such as input of features, constraints, geology, engineering parameters, costs, and alignments. In embodiments it may include calculating earthworks volumes and costs. In embodiments the integrator 102 allows viewing of paths on data terrain models and images in a range of graphics files, such as bitmaps, jpegs, etc., enabling comparison of paths and/or projects on an ‘apples-to-apples’ basis.

Thus, in embodiments of the methods and systems described herein the client-based application 102 may be provided as a stand-alone product without connection to the pathfinder 108. A stand-alone, client-based application 102 may provide a variety of features, such as serving as a QS tool for easy calculation of earthworks and very basic cost analysis at the pre-feasibility stage, operating as a presentation tool for early stage projects/pre-feasibility studies, and operating as an audit tool for federal and state governments and aid agencies, enabling comparative assessment of multiple project proposals to determine which have been comprehensively investigated and which should be funded.

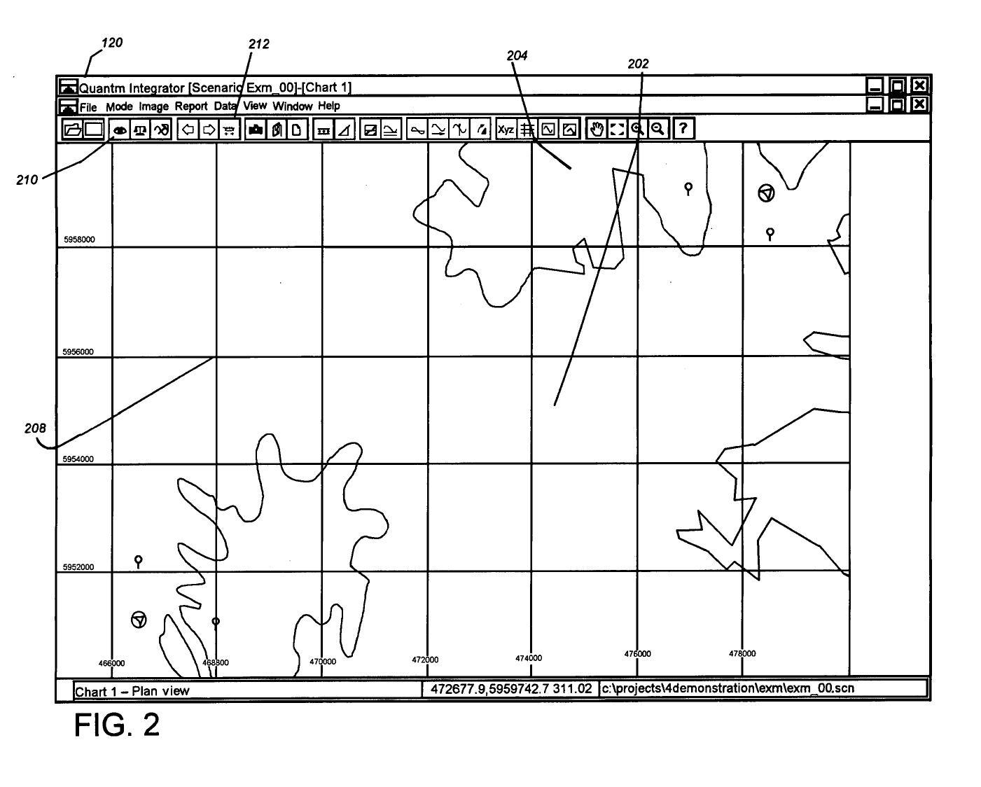

Referring to FIG. 2 the embodiment of the client-based application 102 with the GUI 120 may include a terrain display 202 showing terrain colors for a terrain for an area of a project, such as based on terrain altitude. In an embodiment of the terrain display 202 the higher altitudes may be shown as red, orange, or blue 204 while lower altitudes may be shown as green or yellow 208. The color definitions for the altitude may be configurable by the user. The client-based application 102 with the GUI 120 in an embodiment may have a series of buttons 210 for rapid access to functions, such as allowing the user to zoom in on a particular area of terrain or to navigate to other views of the GUI 120. In an embodiment the client-based application 102 with the GUI 120 may also provide a user menu with a plurality of menu options 212 for the functions of the GUI 120. The buttons 210 and menu options 212 include conventional menu options for programs that use a graphical user interface, such as programs for the Windows®t or Macintosh® environments. For example, the buttons 210 and menu options 212 allow a user to search for stored files (such as files containing stored terrain models to be displayed in the display 202), to save files, to edit files, to switch rapidly between files, to change views, to zoom in and out, to select a portion of a display for further processing, and the like. The buttons 210 and menu options 212 also allow the user to select other functions of the client-based GUI 120 and the server-based application 108, as described in more detail herein. Further details of the operation of the client-based GUI 120 are described in Appendix A, Quantm Integrator User Manual, and Appendix B Quantm Integrator Training Tutorial of U.S. Provisional Patent Application No. 60/569,897, entitled “Methods and Systems for Optimization of Corridors, Routes, Alignments and Paths for Linear Infrastructure,” filed May 11, 2004 and U.S. Provisional Patent Application Attorney Docket No. QNTM-0001-P60, filed May 5, 2005 and entitled “Terrain Design and Mapping Systems.”

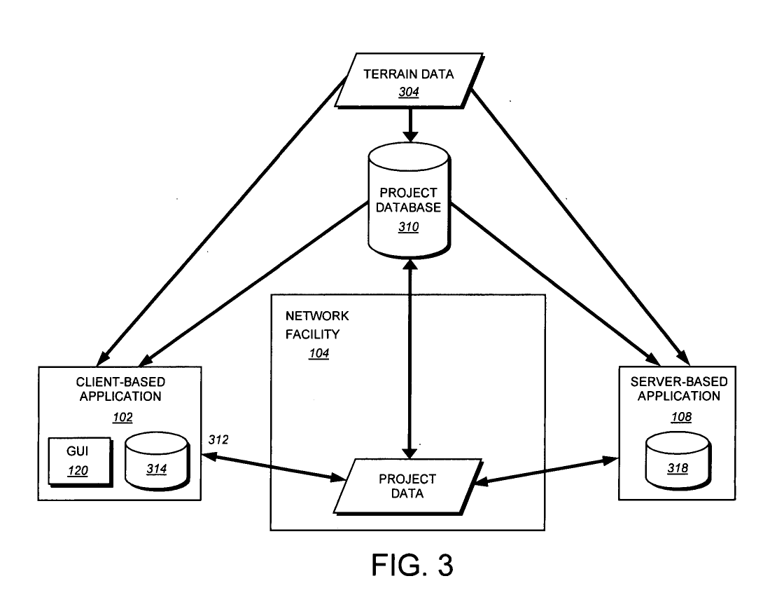

Referring to FIG. 3 the client-based application 102 may include a data storage facility 314 and the server-based application 108 may include a data storage facility 318. In embodiments, terrain data 304 may be loaded into the project database 310, which is either held on a central server or loaded onto both the client-based application 102 and server-based application 108 and stored on 314 and 318. The terrain data may be sent directly to the client-based application 102 and server-based application 108 and held on the project databases 314 and 318 respectively (as shown by the red lines). The Project databases 310, 314 and 318 may be any conventional data storage facilities, including files, folders, databases, disks, memory sticks, flash memory, RAM, ROM, data warehouses, data marts, data repositories, memory, or other facilities for storing data and may reside on the client-based application 102, server-based application 108 and/or a server of the network facility 104. As shown in FIG. 3, project data 312 is communicated among the server-based application 108, the client-based application 102 with the GUI 120, and the project database 310 as shown. At the client-based application 102 with the GUI 120, the terrain data 304 may be a representation of satellite maps, aerial image data, contour maps, Digital Elevation Model (DEM), DXF data, ASCII data, GIS data, Genio data, or other data containing terrain information. Additional data relating to factors such as geology types, costs, crossing rules, noise zones, water currents, weather patterns, and line-of-sight may also be imported digitally or input manually. The user may add constraints to the terrain and may transmit the project data 312 using the network facility 104 to the server-based application 108. The server-based application 108 may transmit project data 312, including paths using the network facility 104, to the client-based application 102. In an embodiment the server-based application 108 may maintain a copy of the project database 310, and the client-based application 102 may maintain a copy of an identical project database in the data storage facility 314 of the client computer. Allowing the same project database to be maintained in both the client-based application 102 and the server-based application 108 may allow the future transfer of smaller files for the path information, such as files that represent only the changes from an earlier state of a data set of the project database 310, rather than the entire data set.

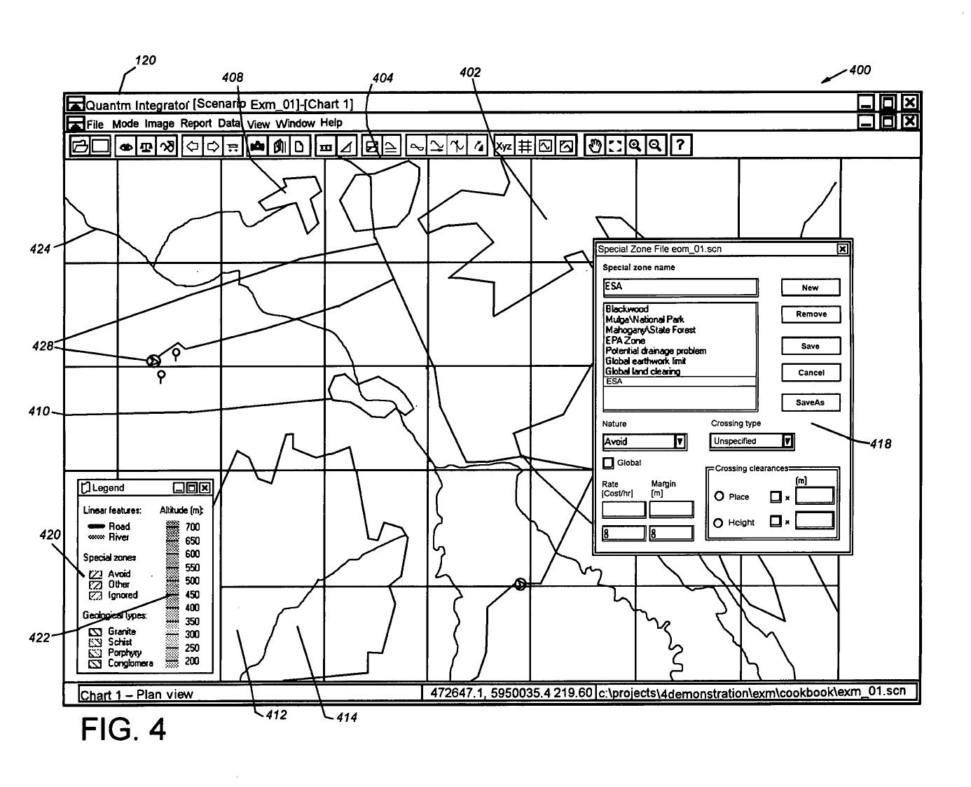

Referring to FIG. 4 the GUI 120 may display various constraints that may be defined on an area of terrain in a constraint display screen 404 of the GUI 120. The various constraint areas may be created by mouse or keyboard input to define a contained area, or the constraint areas may be generated automatically from existing data that may be recorded in digital formats, such as data sets regarding environmental data, map data, property data, zoning data, topographic data, political data, or the like. Compaction factors and percentage of a material that is reusable for fill once extracted may be defined. The software to convert digital data into the required format may reside on the server-based application 108, in the client-based application 102, or on another machine.

In an embodiment of the constraint display screen 400, constraint zones may be of many types, such as geology zones (i.e. bedrock that consists of granite) 402, environmentally protected areas 408, environmentally sensitive areas 410, public lands (such as state forests 412 or national forests 414), private property, specially zoned areas, or other types of potential constraints to a project. The active constraint may be highlighted, such as the environmentally sensitive area (ESA) constraint 410. When a constraint is selected (for example by clicking a mouse on the area), a zone window 418 may be visible. In an embodiment the zone window 418 may display additional refinements that may be selected for the zone. In an embodiment a legend 420 may be visible that provides information about the type of constraint color and shading used for the different constraints. The legend 420 may provide a terrain altitude color scale 422 for reference.

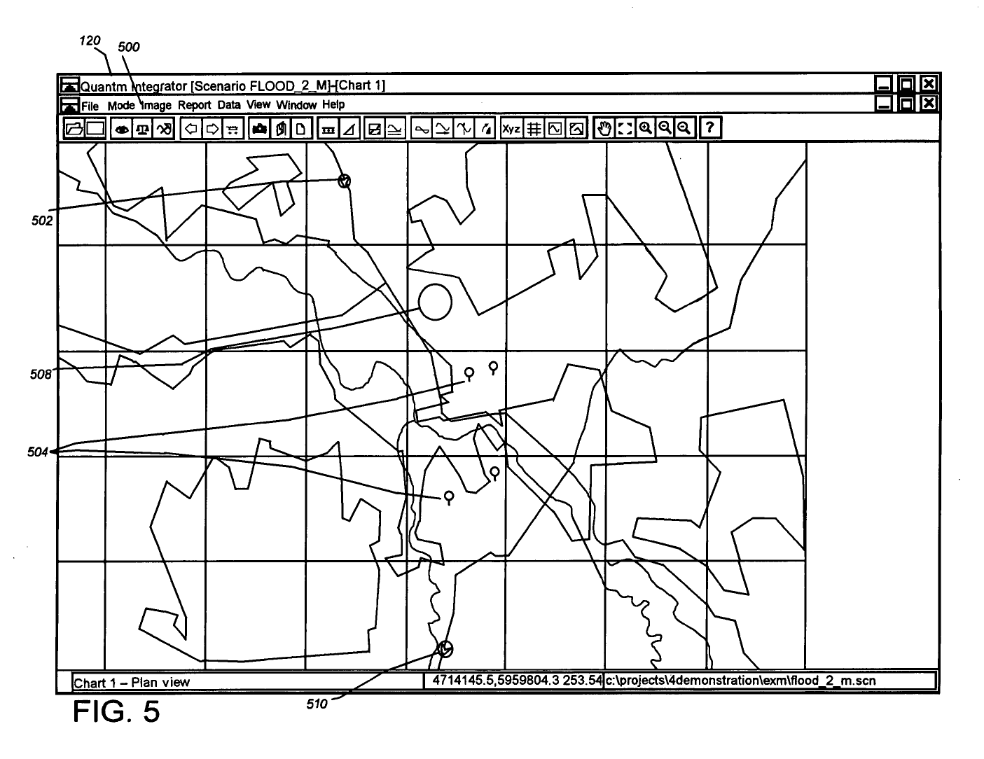

Referring to FIG. 5 in an embodiment the client-based application GUI 120 displays a guide display screen 500 that allows a user to set a starting point 502 and an ending point 510 for the path of a project. The direction and grade of the path at the start and end points can also be defined. The user may also set intermediate guide points 504 or an ‘attractor’ 508 between the starting point 502 and the end point 510 to force the system to investigate path options through a defined area. The start and end points 502, 510, guide points 504, and ‘attractor’ 508 may be indicated by mouse and/or keyboard input. The start point 502 may be the beginning and end point 510 may be the end of the path to be created or may represent a sub-section of the total path.

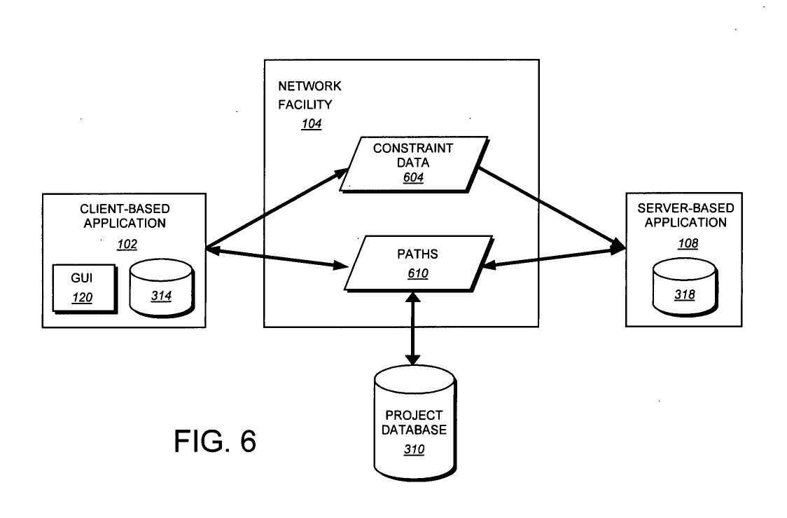

Referring to FIG. 6, the client-based application 102 and the server-based application 108 may exchange constraint data 604 and path data 604, which in each case may be stored, retrieved, and manipulated using the data storage facility 314 of the client-based application 102, the project database 310 for the project, or the data storage facility 318 of the server-based application 108. For example, the client-based GUI 120 may be used to create the constraint data 604 that define constraints on a path, such as prohibition against entering an area, for example if the user indicates that the area is an environmentally sensitive area or that entering the area may result in cost increases, such as land acquisition costs or higher cost geology types (i.e. if the bedrock is granite). The constraint data 604 may be transmitted to the server-based application 108 using the network facility 104. In an embodiment the server-based application 108 accesses necessary data storage facilities for input data (such as information relating to previously stored constraints, information relating to the start point 502 and end point 510 of the desired infrastructure path, information relating to guide points 504, 508 stored for the particular infrastructure path, and any other information needed to calculate potential infrastructure paths). The server-based application 108 then generates a plurality of potential infrastructure paths. In embodiments the server-based application may generate millions of potential infrastructure paths and then may select a smaller number to transmit to the client-based application for presentation on the client-based application 102 in the GUI 120. The infrastructure paths 610 may be transmitted using the network facility 104 to the client-based application 102 and to the project database 310. It should be noted that the client-based application 102 may maintain a project database 314 identical to the server-based application 108 project database 318 or an external project database 310 allowing for incremental data to be transmitted, rather than requiring all project data to be transmitted every time a change happens. Multiple scenarios can be submitted to the server-based application to support an iterative process for investigation of constraints and selection of a path.

In an embodiment using this process repeatedly, multiple paths 610 may be developed using “what if” scenarios by revising constraint data 604. In an embodiment, one path may be selected from an existing set of paths and run with different seeding or optimization parameters. This may yield a refined path 610. In an embodiment changes may be made and new constraint data 604 sent to the server-based application 108 that may generate a different set of possible paths 610. The “what if” iteration process may uncover a path 610 that may yield lower cost, a more acceptable path, or other different path. In an embodiment the “what if” iteration may be performed as often as the user sees fit, thus helping create a path that meets the design/engineering requirements. In an embodiment the iteration process may be completed significantly faster than traditional planning, and many different path possibilities may be reviewed in a short period of time.

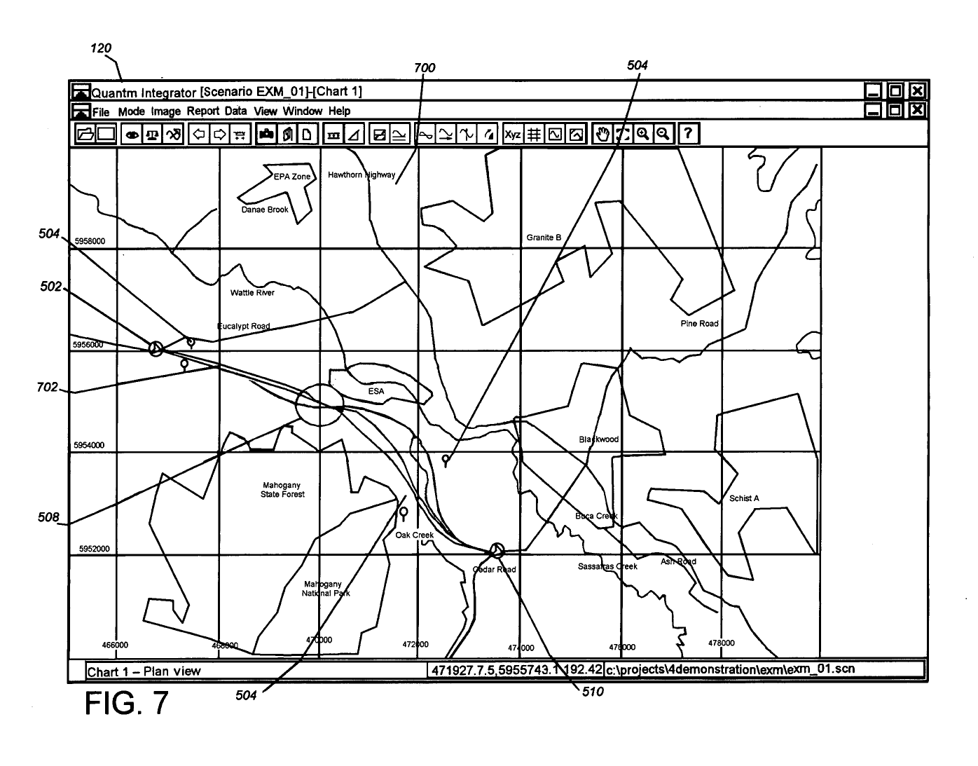

FIG. 7 shows an embodiment of the client-based GUI 120 with a path display screen 700 showing a plurality of paths 702 displayed on the client-based GUI 120. The plurality of paths 702 may be displayed on the client-based GUI 120 with constraints similar to the constraints 402, 404, 408, 410, 412, 414 described in connection with the constraint view 400 of FIG. 4. The plurality of paths 702 may be shown originating from the start point 502 and continuing to the end point 510. The paths also may be constrained by the guide points 504 or attractors 508.

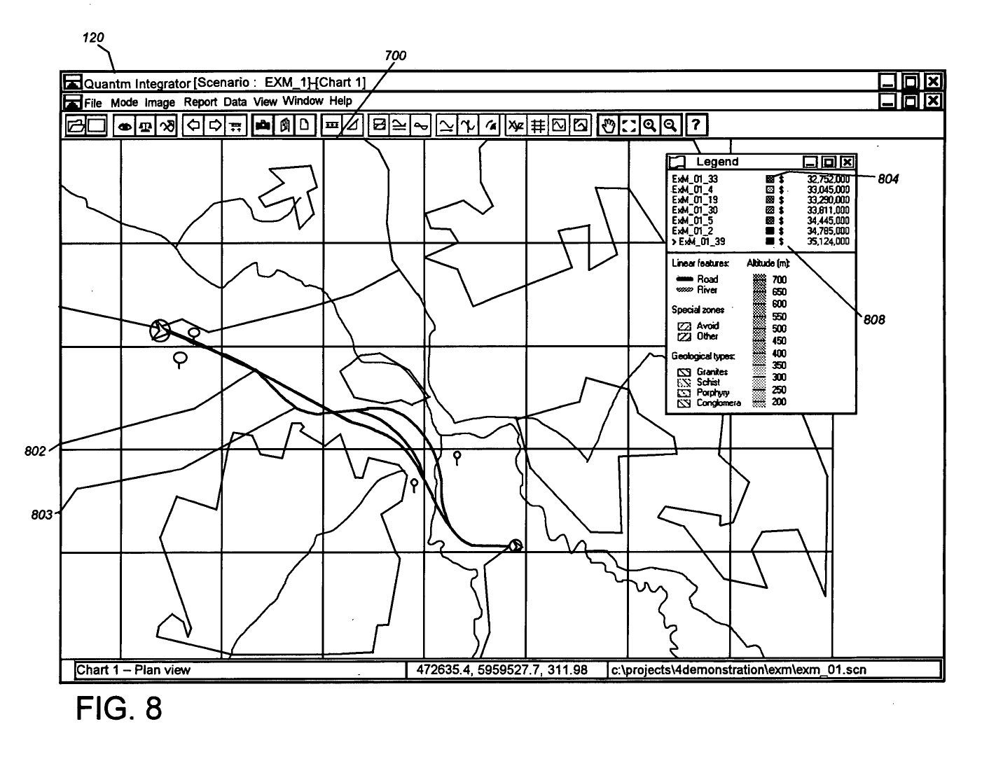

FIG. 8 shows the path display screen 700 of the GUI 120 with one or more paths 802 shown. With the selected path 802 a legend window 804 may be displayed to provide cost information on the paths 802. The legend window 804 may display the costs of all of the displayed paths and indicate a particular highlighted path 803 in a different color 808. The legend window 804 may also display information on altitude, zones, soil type, or other constraints. The cost information may be determined by an algorithm, such as executed by the server-based application 108 interacting with the data storage facilities to retrieve cost data associated with various paths. In an embodiment violations of constraints for any selected path may be listed in a report that displays existence, location, and extent of the violation.

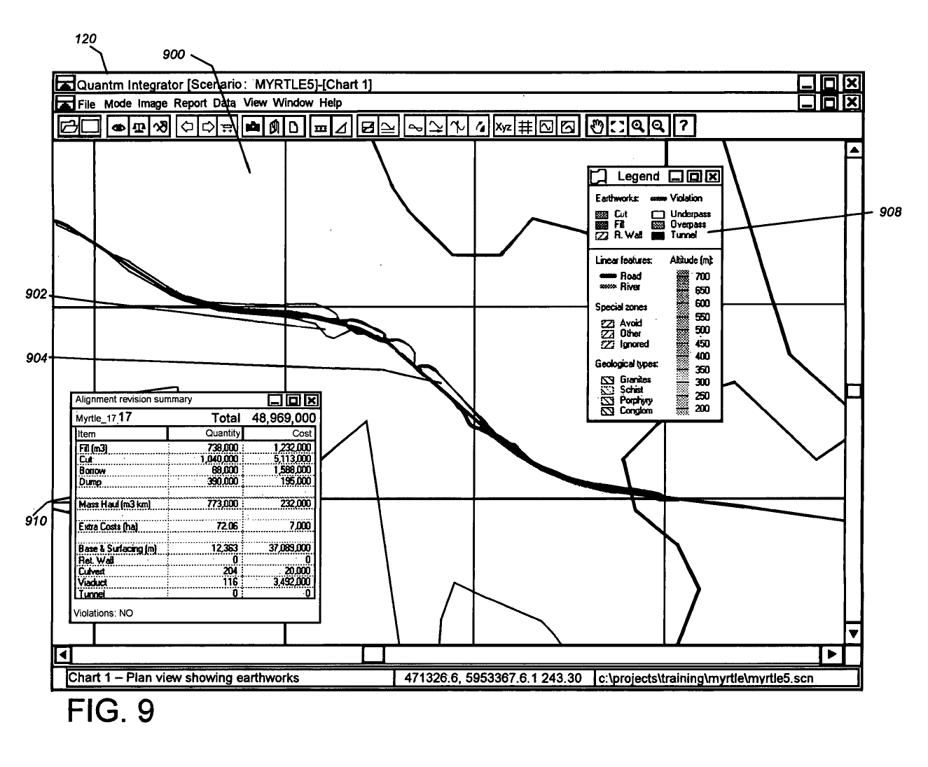

FIG. 9 shows an embodiment of the client-based GUI 120 showing an earthworks display screen 900 for displaying earthworks requirements and area of footprint for a path. Earthworks on the left and right banks of a path can be viewed in both plan and profile aspects. The cross-section for each path can be viewed in user-defined locations along the path or can be viewed dynamically, during which the cross-section is shown in real time as the cursor is moved along the path. Cross section reports may provide edge of pavement, turning points of the earthworks, and the natural land surface for each selected path. Mass haul may be displayed to show the volumes and movement of spoil and usable material for the project.

In this view the earthworks may be shown graphically with cut requirements 902 and fill requirements 904. A legend window 908 may be displayed to indicate the colors and shading associated with earthworks and structures. The legend window 908 may also display information on altitude, zones, soil type, or other constraint. Portal costs for tunnel entrance and exits may be defined. A path summary 910 may be displayed that will indicate the quantity and cost of various earthwork, structure, and base and surfacing (or ballast for rail) requirements. The earthworks calculations may be based on the volume and type of earthworks and structures required along with defined unit costs for each. In an embodiment earthwork volumes may be calculated with benches being automatically inserted, as defined by the user for each geology and strata, from the alignment, up or down, to the land surface. In an embodiment the volume of earthworks may be calculated based on the shape of the land surface within the limits of the earthworks. Alternatively, the land surface may be calculated as a straight line between several points between the limits of the earthworks at the land surface.

Unit costs may be based on user-defined parameters or may be derived from a library of costs that may be stored in the software or be downloadable from the internet.

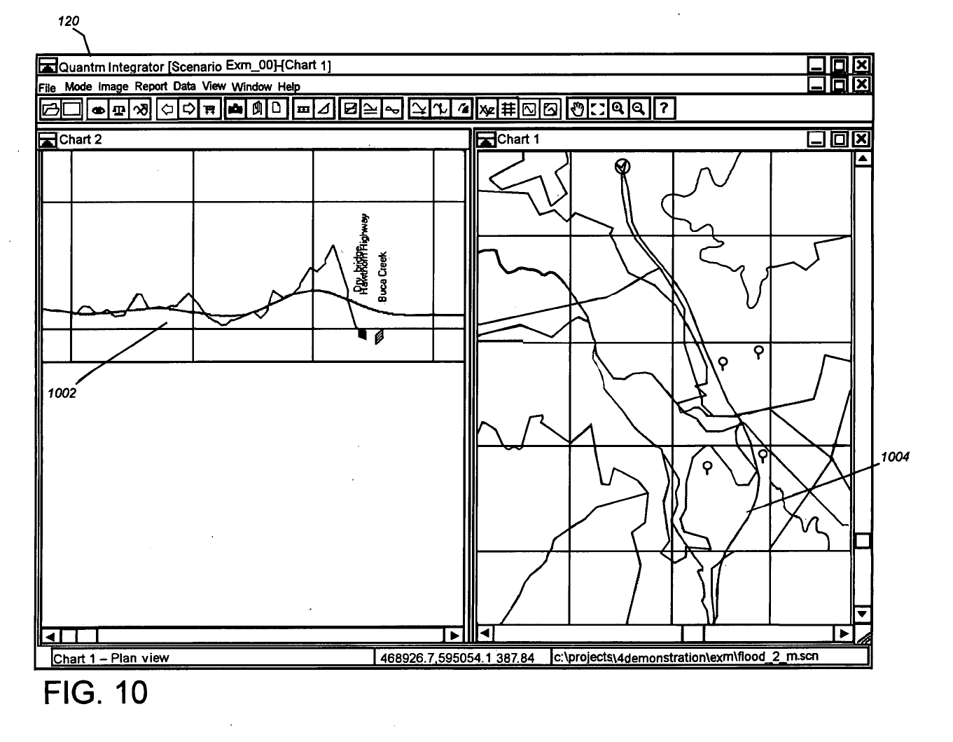

Referring to FIG. 10, an embodiment of the client-based GUI 120 is shown with a selected path in a profile view 1002 and plan view 1004. The profile view 1002 may be shown with the plan view 1004 or shown separately. The profile view 1002 may show the path distance (or chains) along with the display of the terrain altitude before or after cut and fill. The plan view 1004 may be shown with the profile view 1002 or separately, and multiple paths can be simultaneously compared in the same views.

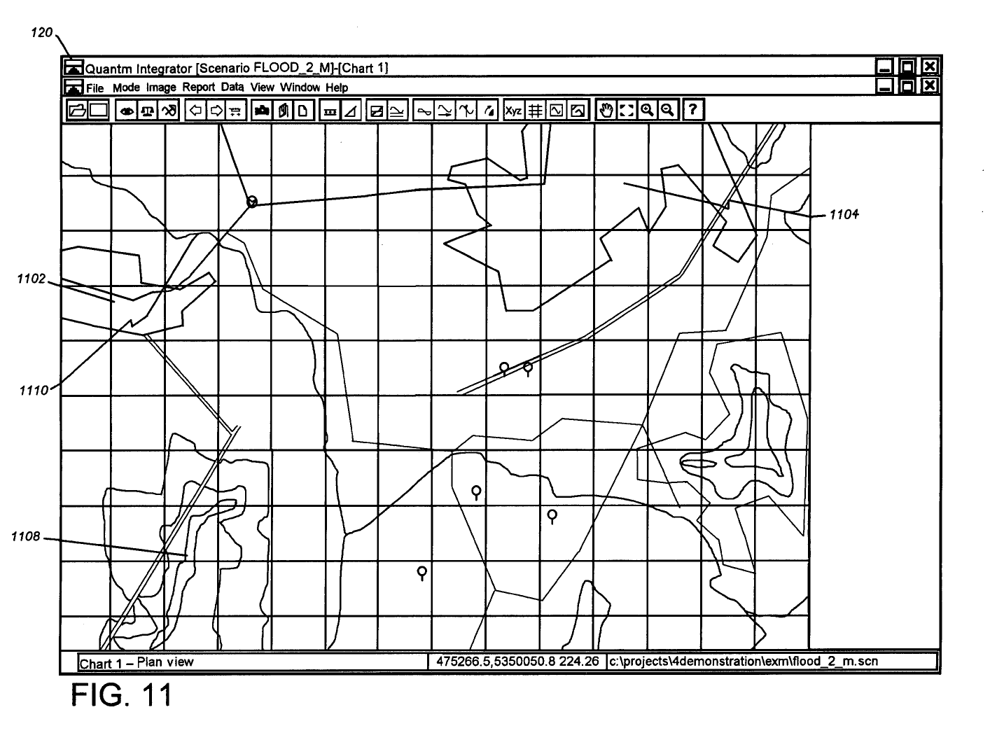

FIG. 11 shows an embodiment of the client-based GUI 120 using an orthorectified aerial image 1102 as the background. The constraints may be displayed with the aerial image 1102, such as geology zones 1104, forest 1108, rivers 1110, or other constraints.

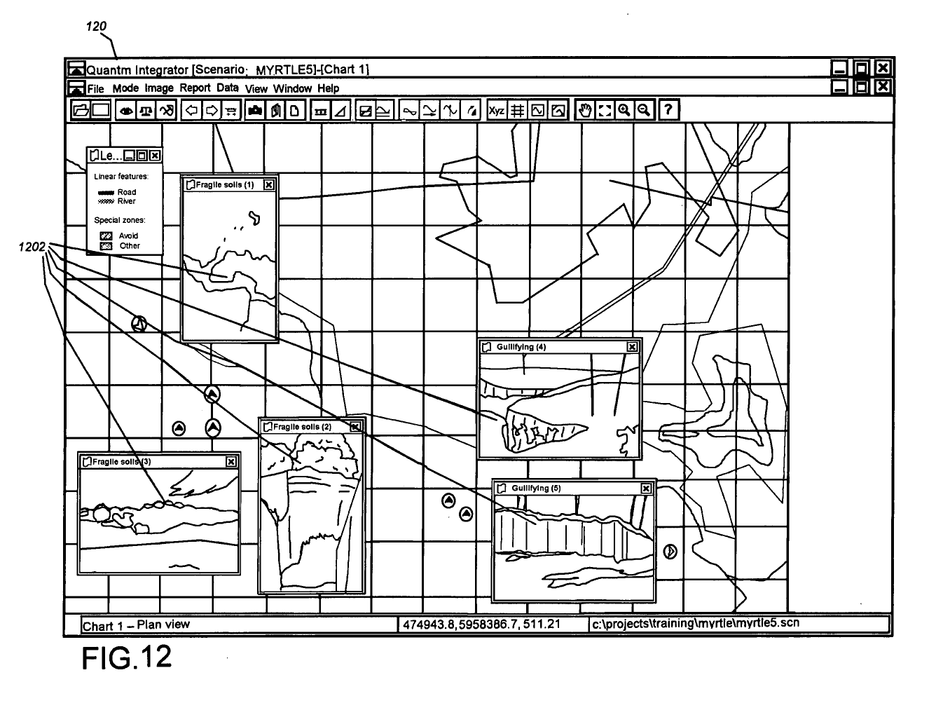

FIG. 12 shows an embodiment of the client-based GUI 120 with an orthorectified aerial image as a background 1102 where the view includes popup files/images 1202 to provide a visual depiction of the path location or views from where the proposed path will be located. These popup files/images 1202 may be used to allow the visualization of a particular location and may be graphics, images, videos, reports, letters, or other files or documents associated with a particular feature or location of a project. Visualization may support presentations to public and project stakeholders and may also limit added trips to the field site to see a particular terrain.

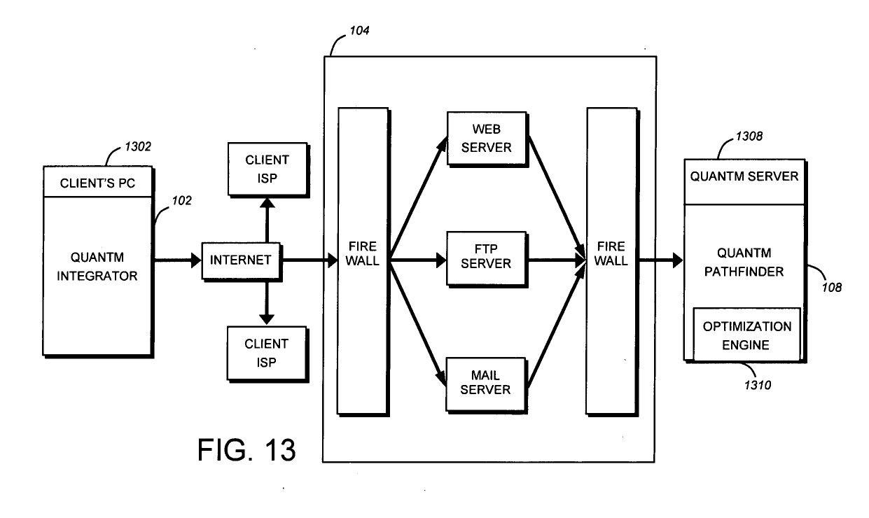

FIG. 13 shows additional details of an architecture of the methods and systems described herein. The system can operate as software that can be installed on a stand-alone PC or in an Application Service Provider (ASP) format, where the ‘front end’ software package or client side application 102, or integrator, is loaded onto the user's desktop PC 1302. A project database is created and loaded onto the project database 310 and onto the data facility 314 of the client machine 1302. The project database may include a digital terrain model loaded onto the client machine 1302 and on a server 1308 that runs the server-based application 108. The server-based application 108 may include an optimization engine 1310 for optimizing paths based on constraints, costs, geology, engineering parameters, crossing rules for features, and zones. The user can create project scenarios (unique sets of constraints, engineering specifications, geology, unit costs, etc. that define the problem) in the client-based application 102. The user submits scenarios (project data files) to the server-based application 108 via the network facility 104. The optimization engine 1310 of the server-based application 108, or pathfinder, evaluates millions of path options and then creates a file containing a number of low cost paths that is returned to the user, via the network facility 104. The user can open the file in the client-based application GUI 120, the integrator, and review the paths in plan and profile over a digital terrain model or bitmap images to view curve, grade, earthworks, cross sections, and volume/cost reports. The process described can be repeated multiple times to enable sensitivity analysis, demonstration of consideration of alternatives, consideration of emerging constraints, response to public consultation, or consideration of more accurate data, for example geological data, that is gathered as the project proceeds.

The client-based application 102, or integrator, can be used to combine DTMs with defined physical and social constraints to display optimal paths and calculate quantities and costs. Using terrain data that has been derived from geo-spatial imaging, such as 10-meter resolution satellite images, aerial photography, or contour maps, the integrator 102 facilitates selection of the most suitable corridors for the path at the macro level. Once a suitable corridor is located, more accurate, micro-resolution imaging, such as 0.5-2 m resolution, may be used to optimize site selection for future, more detailed path (alignment) planning. The integrator 102 may also be used to trace the linear features and zone boundaries of the terrain and complete data dialogue boxes. In this way, the integrator 102 allows input and consideration of detailed and necessary data on geological strata, drainage, and earthwork fill and removal.

In embodiments the integrator 102 resides on the client personal computer 1302 and is designed to operate in conjunction with the server-based application 108, or pathfinder. Once the client has used the integrator 102 to define the data input (spatial imaging) and physical and social constraints, the integrator 102 output is transferred to the pathfinder 108 optimization system 1310 residing on the server 1308.

In embodiments the integrator 102 is the client based front-end graphical user interface (GUI) that is also capable of computational output of project costs and has additional Quick Seed functionality to enable the project teams to draw their own paths as the basis for seeded optimization. The integrator 102 provides the project team with control of the planning process and an ability to submit scenarios to the server-based pathfinder 108 for optimization using the optimization engine 1310.

In embodiments the project team can manually create paths or input pre-defined paths into the integrator 102 to quickly determine the cost of the paths using the integrator 102 automatic costing function.

In embodiments the client computer 1302 is a standard PC with an Intel, Apple, Linux or other processor and Internet connection. Other configurations may be used. In embodiments the server 1308 includes a server and a cluster of other computers, such as PCs, to enable parallel processing. The integrator 102 and pathfinder 108 could be combined in a single software product for loading on a single PC (as per conventional software distribution).

The server-based application 108, or pathfinder, uses optimization algorithms for path modeling, enabling rapid development of multiple path alternatives in a format that can easily incorporate diverse external data sources without major model rewrite. The compatibility of the pathfinder 108 modeling output with external data sources facilitates an incremental planning process and multiple scenario analysis to allow outputs to, and consider inputs from, energy, life of project, environmental, travel time, user-cost, and noise modeling software/models. Less expensive, crude data may be used during the early macro-level planning or corridor/feasibility studies; more costly detailed data can be added once they are available, the need is apparent, or the choice is justified/viable as a result of identification of a suitable corridor.

Data on physical and social constraints defined at the development stage using the client-based integrator 102 are used as limiting parameters by the server-based pathfinder 108 to generate the set of path options best meeting the project team's goals. Examples of this type of data include cost data in the form of estimates based upon the construction cost of materials, cost of earthwork removal, and design “penalties” invoked when a path is forced by the terrain or conflicting constraints to fail specified design/engineering criteria, such as minimum curve radius and maximum grade or elevation. This iterative process provides objective, constraint, and data-driven path optimization that is free of human bias and preconceptions. The paths created with the optimization engine 1310 of the pathfinder 108 are then transferred back to clients' personal computers 1302 and can be displayed within the client-based integrator 102 and superimposed on any of the plan views of the integrator GUI 120. The project team can define constraints, revise input, or select from the range of path options that meet the constraints. Once the optimal path is selected, the resulting path may serve as a starting point for design refinement and be exported in a range of formats to software such as a CAD program. In an embodiment the final path may be exported in a range of formats, such as ASCII strings, CSV strings with earthwork quantity/cost at user nominated interval, or as DXF/Shape strings, that will allow it to be imported into CAD packages where the preliminary design for the may be commenced.

In embodiments the pathfinder 108 may be a bureau-based back end computational engine of the system, which resides on a secured clustered group of Intel servers and is capable of computing approximately 12 million paths per scenario.

The methods and systems described herein provide a unique path optimization system that assists project teams in the selection of paths that meet the objectives of minimizing project construction cost while satisfying predetermined design/engineering rules and project constraints.

The methods and systems can be applied from the feasibility/corridor selection stage through the path selection phase (including community and environmental consultation) and in the early stages of design—before the path location is fixed. Paths can be exported into standard design software for the next phase of the project.

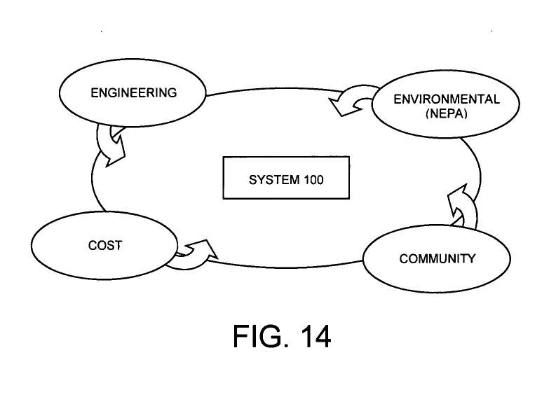

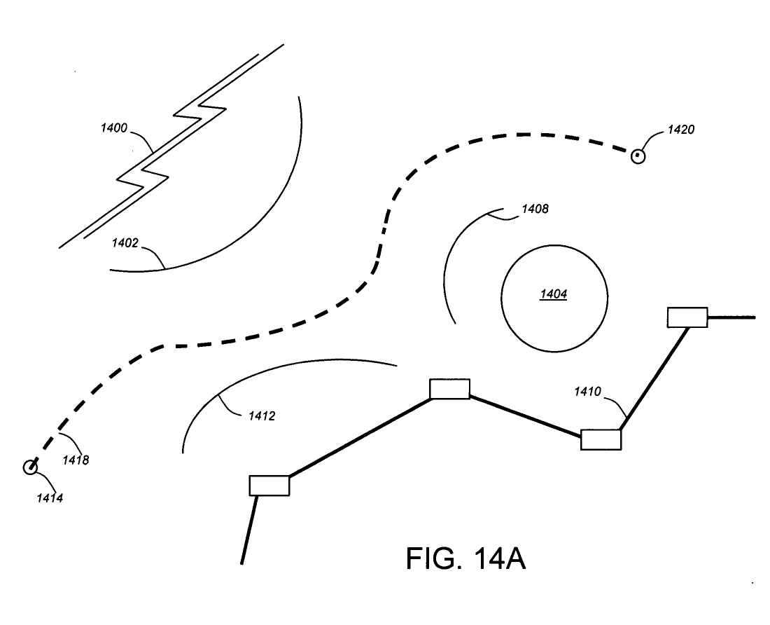

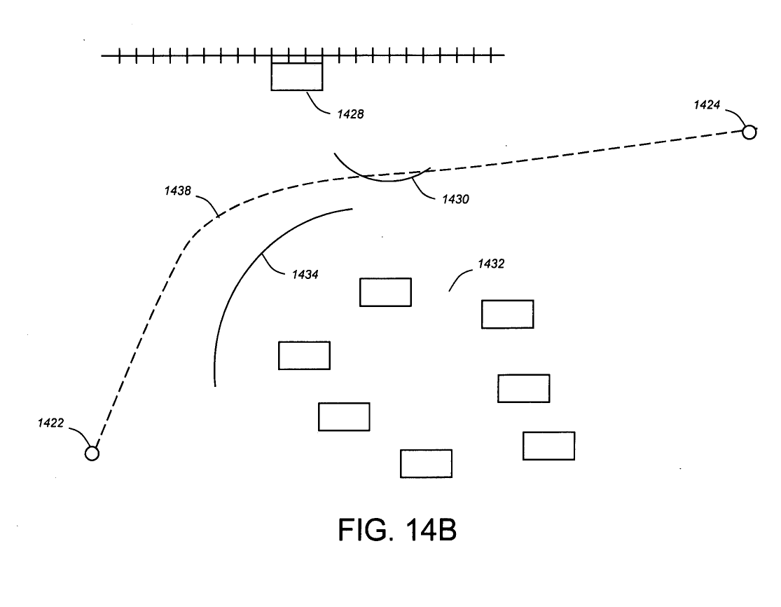

Referring to FIG. 14, the methods and systems allow multiple factors to be integrated into a single analysis, including engineering factors, environmental factors, cost factors, and social or community factors. The process contrasts with current planning, which can be described as a disaggregated process of constraint evaluation or a sequential circle of planning that can lead to conflict among agencies and disparate communities, social groups, and stakeholders and thus create considerable delays in the project. The system 100 can enable all of these factors to be considered simultaneously in a single analysis. Within each of these ‘interested’ groups there can be multiple agencies, departments, service providers, consultants, and other interested parties (representing the environment, heritage, and communities). The system 100 allows multiple parties to interact with a project, adding or modifying constraints in a collaborative model.

In embodiments the system 100 can be used as a communication or collaboration tool, whereby the main agencies associated with the determination of constraints and review/approval of paths could have versions of the integrator 102 on their desk PC 1302 where they can view (as opposed to operate) the integrator 102 and review the paths and their proximity to certain constraints, zones, or existing features or urban developments. Using variable access levels, through password, product keys, or dongles, the agencies and consultants can be given access that may or may not allow data input and may provide variable access to different levels of detail on the paths that are distributed for review

This has the potential to improve the workflow of the project—no longer requiring face-to-face meetings with agencies to review/discuss constraints and paths. It can enable increased participation and reduce conflict through a collaborative approach and a comprehensive review in a transparent process. It also can enhance the contribution of the audit function of the system by being able to document planning decisions and the review and sign-off by the various agencies, and it may provide a Management Information System tool for Project Managers and other senior level managers to track progress in the project and ensure that regulations and legal obligations have been complied with.

Referring to FIG. 14A, a schematic of path determination using avoidance zones is shown. When creating path determinations, there may be features in the region that require a path determination to be sensitive to avoidance rules. The avoidance rules may relate to a zone of geological instability, of political instability, of political sensitivity, of historic or cultural significance, or with an environmental constraint, at least one of a threatened species or an endangered species, a legal boundary, a high cost of development, a governmental order, or a zoning regulation.

In an embodiment, a region for a path determination may consist of a fault line 1400, pipeline 1410, and a site of historical significance 1404. Each of these features may have avoidance zones that may be unique to each feature. The avoidance zones may be maintained in a database or file and may be applied to the path determination project as needed. In an embodiment, the fault line 1400 may have an avoidance zone 1402 that has a significant depth and width. In an embodiment, the pipeline 1410 may have an avoidance zone 1412 that runs the entire length of the pipe line 1410 and may have avoidance zones that are different for the pump stations and the pipe. In an embodiment, the historically significant site 1404 may have an avoidance zone that is based on sound and noise avoidance.

In an embodiment, the path determination 1418 may be outside the avoidance zones of all the features in the region.

In an embodiment a zone 1408 may relate to the line of sight from feature 1404, which may need to be avoided for social, environmental or military reasons.

Referring to FIG. 14B, a schematic of path determination using separation values is shown. When creating path determinations there may be the requirement to both maintain a minimum separation from a feature but also be within a maximum separation from a different feature. The separation values may be maintained in a database or file and applied by the path determination. The minimum separation values may relate to a zone of geological instability, of political instability, of political sensitivity, or of historic or cultural significance, and they may relate to an environmental constraint, presence of at least one of a threatened species or an endangered species, a legal boundary, a significant cost of development, a governmental order, or a zoning regulation. The maximum separation values may apply to bus stations, train stations, or other path determinations.

In an embodiment, a path determination 1438 may have a starting point 1422 and an ending point 1424. There may be a housing development 1432 with a separation value 1434. In an embodiment, the housing development 1432 separation value 1434 may be based on noise avoidance, headlight avoidance, safety of distance from hazardous vehicles, or zoning requirements. The path determination 1438 may be created that stays outside of the minimum housing development separation value 1434.

In an embodiment, a train station 1428 may have a maximum separation value that may require the path determination to be within a certain distance of the train station. The close proximity may allow for easier access from the path determination 1438 to the train station 1428. The path determination 1438 may be created that stays within the maximum train station separation value 1430.

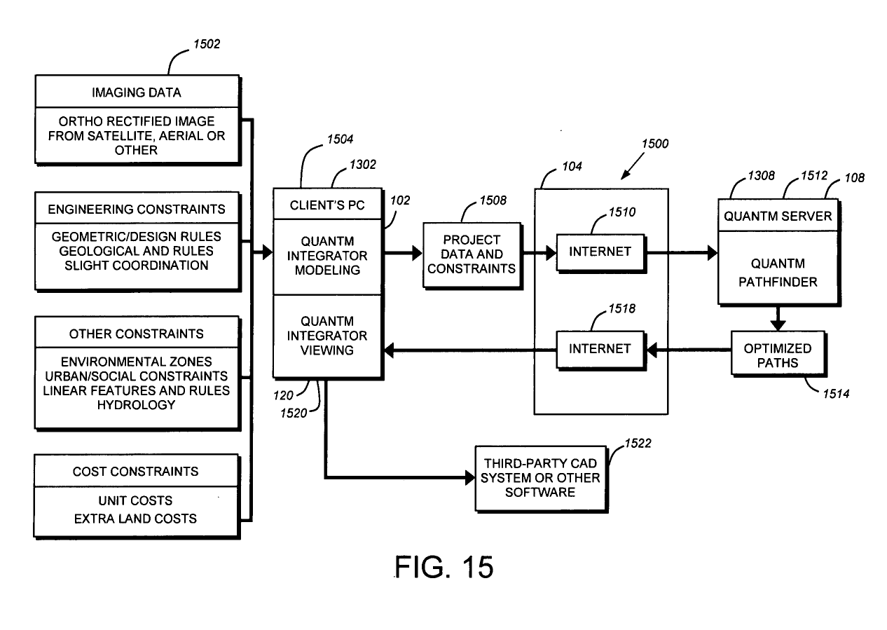

FIG. 15 shows a flow diagram 1500 demonstrating a project flow for a path-planning project. First, at a step 1502 data may be gathered relating to the path, such as terrain data, aerial or satellite images, contour maps, engineering constraints, geology, environmental constraints, urban/social constraints, linear features, and crossing rules and cost data. The data may be entered in the client-based application 102, or integrator, at a step 1504, where the user interacts with the GUI to add or modify constraints, set start and end points for a path, and enter guide points, attractors, and the like. The digital terrain model and other project data are loaded on both integrator 102 and the server-based application 108, or pathfinder, on the server 1308. The server-based application uses the optimization engine 1310 at a step 1512, generating a selected set of potential optimized paths at a step 1514, which may be transmitted in a step 1518 over the network facility 104 back to the client-based integrator 102, where the user can view the potential paths in the viewer of the client-based integrator 102 at a step 1520. Preferred paths can be exported at a step 1522 to a computer-aided design system to produce a final path design, or to other software such as travel time or noise modeling. The user of the methods and systems described herein as preliminary steps allows effective path selection to ensure optimal paths have been identified prior to using the expensive, and resource and time-consuming, computer-aided design programs.

In embodiments the project database may be stored in a data storage facility 310 that can be accessed by the client-based integrator 102 and the server-based pathfinder 108.

The system 100 can be used in connection with a variety of different types of projects. In certain embodiments, the methods and systems are used for planning road and rail projects.

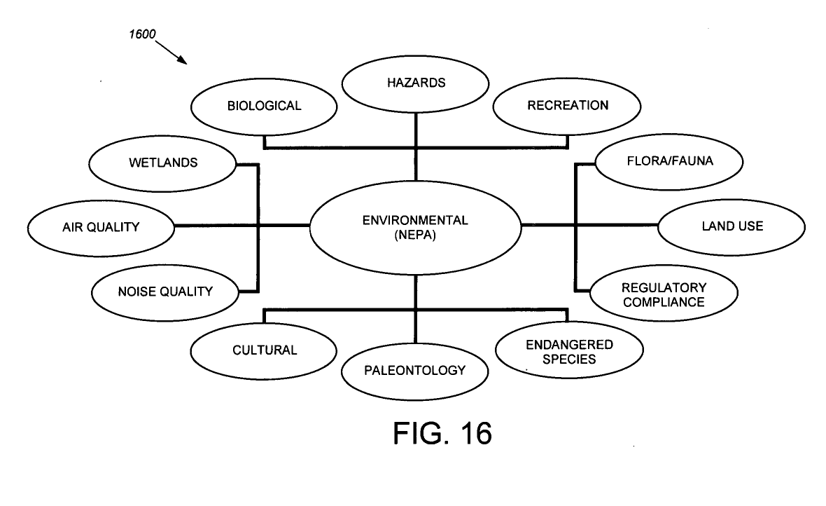

Referring to FIG. 16, a diagram 1600 shows a plurality of constraints that may need to be satisfied for an environmental study or to gain legislative approval, demonstrating the benefit of having collaboration and communication tools that enable integration of inputs from the various agencies, consultants, and/or groups. The system 100 can be deployed on a plurality of client computers 1302, where multiple users can access views of the client-based application 102, such as are served from the project database 318.

The optimization of linear projects can provide value to environments outside of road and rail applications. One environment in which embodiments of the system 100 may be deployed is the planning of canals.

Another environment in which the methods and systems used herein may be effective is in planning pipeline projects, such as gas, liquid, oil, or slurry.

Another environment in which the methods and systems used herein may be effective is in planning telecommunication lines. The telecommunication line may be a telephone line, DSL line, TV cable line, copper wire, coax cable, fiber optic line, microwave communication facilities, above ground cable, and below ground cable.

Another environment in which the system 100 may be deployed is in connection with conveyors that are used on mine haul projects. Mine haul projects are consistently challenged with determining the most appropriate infrastructure for transporting material and then determining the best location for that infrastructure.

In addition, the approach can support a comparison of alternative infrastructure types, such as road and rail for passenger or freight transport, or rail, road, conveyors, and slurry pipelines that may be options for mine haulage projects.

In addition to other constraints, in embodiments the system 100 can be used to provide energy and travel time modelling, such as for rail projects, as well as noise modelling, life-of-project-cost, and user costs for all paths. Historically, energy, travel time, and noise models are applied to pre-determined paths, and alternatives are only investigated if they fail to meet minimum requirements; that is, there is no concept of identifying improvements or alternatives. In embodiments, output from the system 100 can be utilised in a variety of modelling programs to investigate alternatives and carry out potentially extensive sensitivity analysis, allowing trade-off between factors such as construction cost and operating cost. Such programs can be provided separately, or they can be integrated modules of the server-based application 108, such as being used in the optimization engine 1310.

In embodiments the client-based application 102 may present dialog boxes for third-party analysis tools in the GUI 120 and provide a facility for exporting data from the integrator 102 to the third party analysis tools.

In embodiments the system 100 may be used for planning paths for road and rail projects based on a Digital Terrain Model (“DTM”) and the simultaneous consideration of the engineering requirements and costs, environmental constraints, social constraints, and land acquisition costs. In embodiments the system 100 may permit identifying many alternative path options (such as 10 or more) to determine a preferred road or rail path that considers engineering requirements and costs, environmental constraints, social constraints, and land acquisition costs.

In embodiments the system 100 may support a process that enables import of shape files from programs such as GIS programs for integrating environmental and social zones into a path selection process that simultaneously considers cost and engineering constraints.

In embodiments, the system 100 may support a process that enables export of shape files from a path selection process that simultaneously considers cost, environment, and engineering constraints.

In embodiments, the system 100 may be used for planning the location of roads, railways, canals, hydro-electric canals, hydroelectric plants, gas and liquid pipelines, conveyors, harbor dredging projects, and telecommunications or multipurpose utility lines or pipes.

In embodiments the system 100 may include an encryption facility for providing a security feature for a digital terrain model, such as to limit access to certain data or the model to individuals who have clearance to view the data.

In embodiments the system 100 may be used by departments of transportation or similar entities for managing road plans or budgets for public works projects.

In embodiments of the invention various crossing types are considered as constraints, such as rivers, roads, and railways. In embodiments the extent of earthworks required to complete a project can be included in calculations and displayed in the client-based GUI 120. The physical extent of the regions of cut and fill can be displayed horizontally and vertically. In embodiments other features such as overpasses, underpasses, tunnels, bridge abutments, and viaducts are displayed.

In embodiments costs are calculated for earthworks volumes for removal and fill actions, including shallow cuts, deep cuts, culverts, retaining walls, viaducts, or the like.

Cost calculations can include land acquisition costs, penalties, and other cost factors.

The system 100 can be used to generate a report, such as a report showing quantities and costs aggregated over paths as well as costs over specified intervals of the path. In embodiments the system 100 can factor in energy consumption, such as anticipated greenhouse gas emissions, fuel consumption, and similar factors associated with path changes.

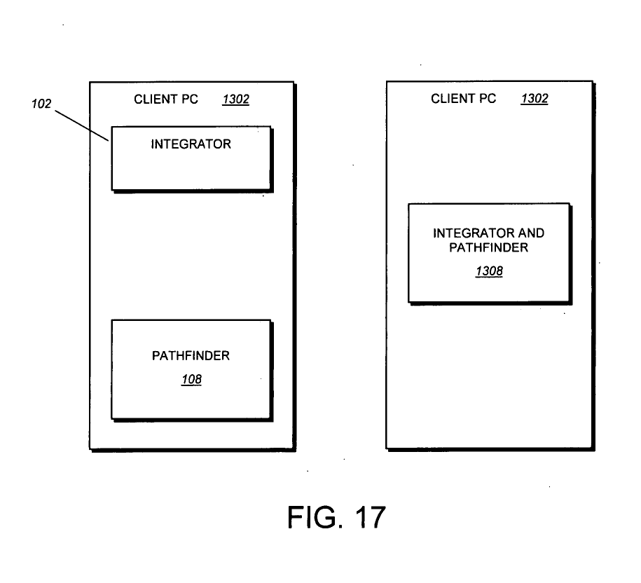

For example, a topographical constraint may show that polluting gases emitted along a path are likely to be held within an area because of terrain features that tend to prevent movement of air. Referring to FIG. 17 an embodiment of the client-based application 102 and the server-base application 1308 installed as a single product on a client personal computer 1302 is shown.

In an embodiment the client-based application 102, the integrator, and server-based application 108, the pathfinder, may reside on the same client personal computer 1302 as two separate pieces of software that communicate with each other. In an embodiment the client-based application 102, the integrator, and server-based application 108, the pathfinder, may be combined as a single product and reside on the client personal computer 1302. In an embodiment the single application may be shrink-wrap packaged, provided by a consulting firm, downloaded from the internet, or received by other method. The client or a consultant on the client computer system may install the single product. In an embodiment the client-based application 102 may function as a stand-alone product on the client personal computer 1302. In an embodiment the server 1308 may be installed as a service on the client PC 1302, and the server-based application 108 may run as part of the service.

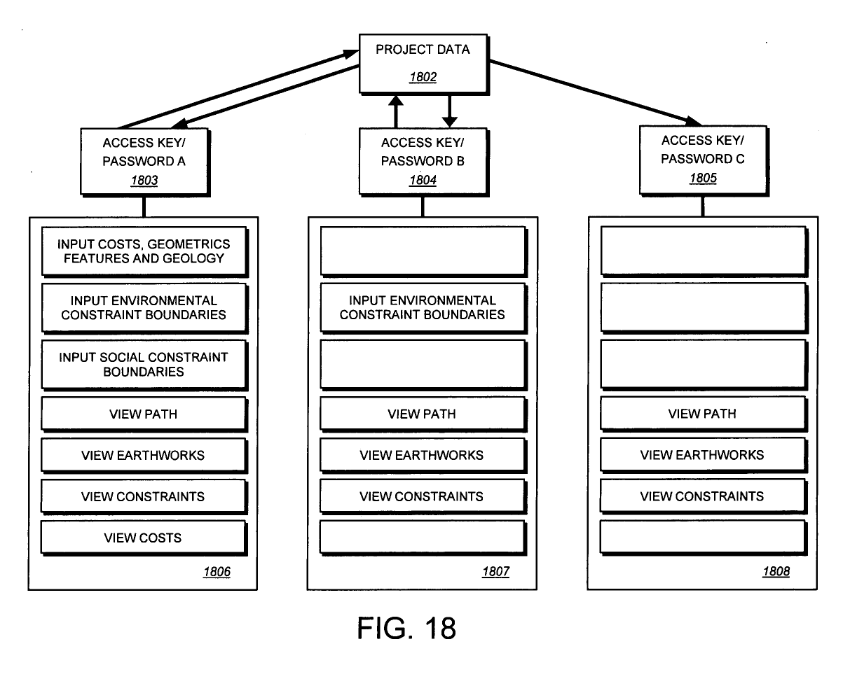

Referring to FIG. 18 the members of various organizations involved in the project can access varying levels of data input and review 1806 through 1808 on the client-based application 102, using different password permissions/access keys 1803 through 1805. In a path-planning project it may not be advantageous for everyone to have full access to the project. In an embodiment the client-based application 102 may be accessed through a role-based password permission scheme 1803 through 1805 prior to accessing the path software. In an embodiment the role-based password permission 1803 through 1805 configuration may be user-definable to allow users different levels of access to the path project information. In an embodiment, based on a user's role, one form of password permission 1803 may provide full access to all data input fields and review capabilities. Other forms of password permission may limit the user to just the areas 1807 and 1808 that are permitted by the user passwords 1804 and 1805. In an embodiment the project data 1802 may be sent to the various users through the internet, on CD, or other file storage media; held on a single PC that allows remote access; or held on a remote server. In an embodiment the role-based password permission 1803 though 1805 may allow users to access the client-based application 102 from a plurality of computers. In an embodiment remote users may use web-based viewing applications such as PCAnywhere or VNC to access the client-based GUI 1302. The web application may have access to the role-based password permissions 1803 through 1805 and control access by the client-based application 1302. In another embodiment the client-based application may provide version tracking so that all permitted users may verify the current path. In an embodiment the client-based application may maintain a knowledge base from past projects to indicate best practices and may be accessed with the proper password permission 1803 through 1805. In an embodiment a communication area may be provided to allow the various organizations to communicate ideas on a path project. The capability to remotely view and comment on path options from a plurality of users using remote computers may enable faster planning project completion. With the capability of input from affected organizations, the planning project may proceed to final approval in significantly less time and may result in reduced cost of the entire project.

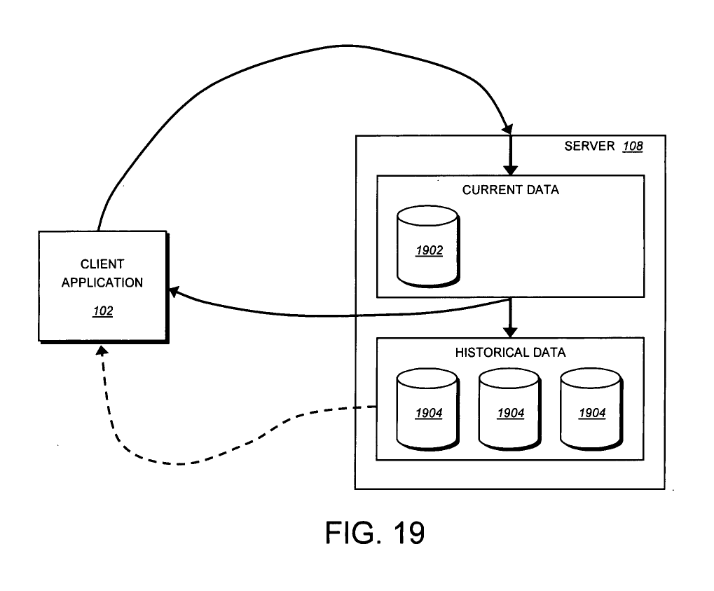

Referring to FIG. 19 an embodiment of storing historical data files 1904 on the server-based application 108 is shown. In an embodiment it may be advantageous to maintain historical data files 1904 for future reuse, and the historical files 1904 may be maintained on the server-based application 1308. In an embodiment a new constraint file may be created on the client-based application 102 and transferred by the network facility to the server-based application 108. In an embodiment the server-based application 108 receives the new constraint file and may store it in the current file location 1902. In an embodiment the previous constraint file in the current file location 1902 may be moved and stored in the historical data location 1904 and may be maintained with other previously saved historical data 1904. In an embodiment the historical data files 1904 may be recalled for future review by being recalled from the client-based application 102. In an embodiment the capability to recall previous files for path generation may be useful if the user needs a previous path because a revision in engineering requirements has resulted in a reversion to a previous path requirement. In another embodiment, using a similar process, the historical data files 1904 may be maintained on the client-based application 102.

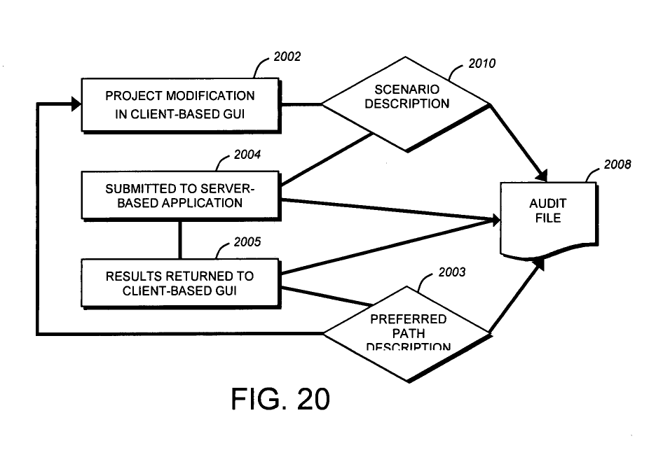

Referring to FIG. 20 an embodiment of an automated audit trail process is shown. In an embodiment the user may make revisions to the project data input 2002, such as engineering parameters, costs, or constraints, in the client-based GUI 1302. In an embodiment notes may be made in regard to data sets, scenarios, and results. These notes may be automatically date and time stamped for audit purposes. The system may require a scenario description 2003 to be completed prior to submitting the file 2004 to the server-based application 102. The scenario description 2003 may be stored in the Audit File 2008 which may reside on the client based application 102, the server-based application 108, or on an independent project database 310. The time of submitting the server-based application 2004 and the receipt of optimized paths 2005 is also stored in the Audit File 2008. The system may require a scenario description 2010 for a selected or ‘preferred’ path to be entered into the system, describing the results and any subjective reasons for selecting particular path(s) for presenting or for further optimization or refinement. In this way, the Audit File 2008 will provide a record of the planning process, the constraints included, and the selection process associated with each optimization and final selected path(s).

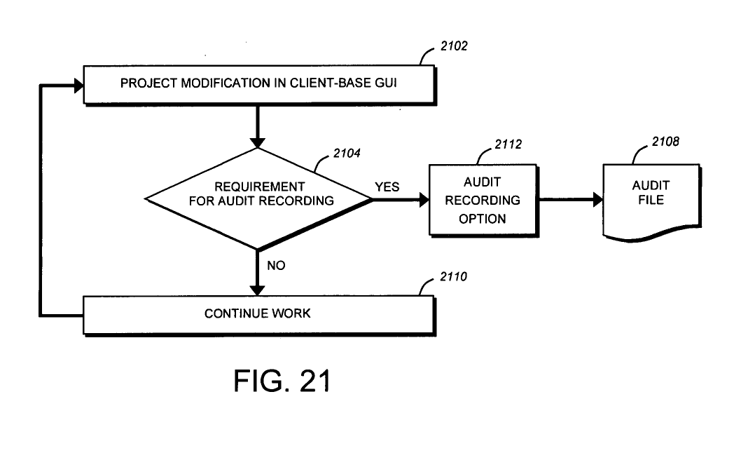

Referring to FIG. 21 an embodiment of an automated audit trail of revision decisions is shown. In an embodiment the user may make revisions to the path 2102. In an embodiment, after a change is made a decision process 2104 may determine if the revision meets audit reporting requirements, such as complying with laws and processes. In an embodiment if the decision process 2104 determines the revision requires audit recording, an audit recording option 2112 may open. In an embodiment the audit recording option 2112 may automatically record the revision made by the user and may require a dialogue be entered to document the audit report option 2112. In an embodiment after the user enters the required data into the audit report option 2112 the data may be stored in the audit file 2108. In an embodiment if the decision process 2104 determines the revision does not meet audit recording requirements (for example the change does not require audit recording or the change fails to comply with legal requirements), then the user is returned for further continued work 2110, which may be to input more data or revise data input at project modification 2102. In an embodiment reports may be generated from the audit file to document the audit trail.

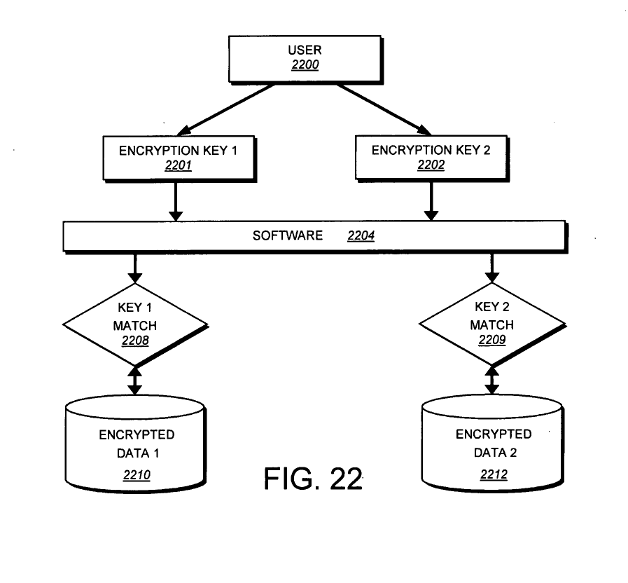

Referring to FIG. 22, a high level flow chart of an encryption-based access control to a system is shown. In an embodiment, an encryption key 2201 2202 may be required for a user 2200 to access a software application, and the encryption key 2202 may limit access to encrypted data 2210 2212 by requiring a key match 2208 2209 to access the encrypted data 2210 2212.

In an embodiment, a user 2200 may be charged for an encryption key 2201 2202 for access to software 2204 before accessing data. The encryption key 2201 2202 may also limit access to a specific project, database, geographic location, or feature by requiring a key match 2208 2209 to the encrypted data 2210 2212. In an embodiment, the database 2210 2212 may be encrypted using the encryption key 2201 2202 therefore requiring a key match 2208 2209 to decrypt the encrypted database 2210 2212.

In an embodiment, a user 2200 may wish to access encrypted data 1 2210 to work on a certain project. The user 2200 may have purchased an encryption key 1 2201 that may provide access to the software 2204 application. In an embodiment, the software 2204 application may have access to a plurality of encrypted databases 2210 2212. The encryption key 1 2201 provided to the user 2200 may only provide a key 1 match to the encrypted data 1 2210. The encrypted data 1 2210 may have been encrypted using the encryption key 1 2201 and therefore may only be decrypted by using the matching encryption key 12201.

In an embodiment, a user 2200 accessing the software 2204 application using encryption key 1 2201 may not be able to access encrypted data 2 2212 because the key 1 match 2208 may not decrypt the encrypted data 2 2212. In an embodiment, access to an encrypted database 2210 2212 may be limited by requiring a key match 2208 2209 between the user encryption key 2201 2202 and the encryption database 2210 2212.

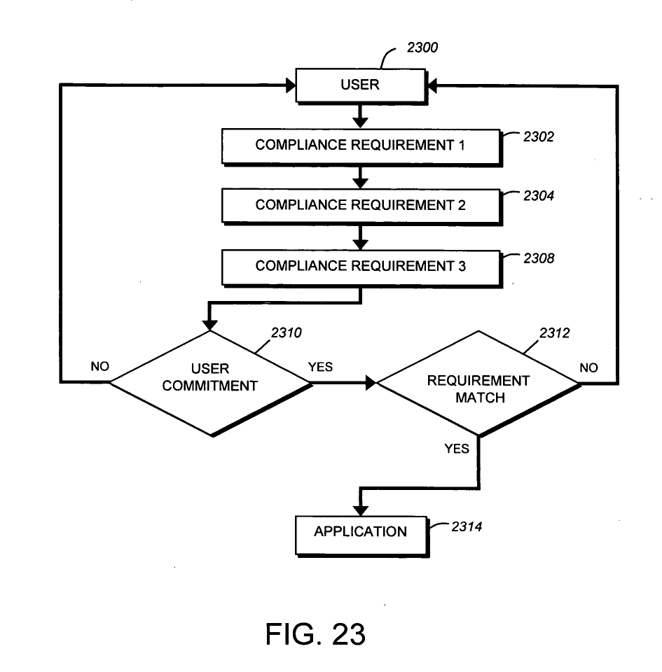

Referring to FIG. 23, a high level flow chart for tracking and documenting compliance analysis is shown. Compliance requirements 2302 2304 2308 for a user 2300 to access an application 2314 or database may be determined and stored as a database or file. The database or file may store a list of statutory or regulatory requirements for an application 2314. An application 2314 may require a user to read and confirm certain compliance requirements 2302 2304 2308 before access to an application 2314 can be made.

In an embodiment, a user 2300 may attempt to access an application 2314. Access to the application 2314 may require a user 2300 to be aware of a plurality of compliance requirements 2302 2304 2308 of the application. As the user 2300 accesses the application 2314, a compliance requirement 1 2302 may be shown that may require the user 2300 to acknowledge a requirement. After acknowledgement of the compliance requirement 1 2302, a compliance requirement 2 2204 and compliance 3 2208 may be shown to the user 2200 and may require user 2200 acknowledgement. A plurality of compliance requirements may be required, based on the application to be accessed.

After the user 2300 has reviewed the compliance requirements 2302 2304 2308, a step may be required to determine the level of the user commitment 2310. In an embodiment, if a user 2300 did not satisfactorily respond to the compliance requirements 2302 2304 2308 the user may be redirected back to the beginning of the compliance requirements 2302 2304 2308. If the user satisfactorily answered the compliance requirements 2302 2304 2308, the user's responses may be matched 2312 to a file or database to determine if the responses match the requirements for access to the application 2314. If all of the compliance requirement 2302 2304 2308 answers match 2312 the application requirements, the user may access the application 2314. If there is a mismatch 2312 between the compliance requirement 2302 2304 2308 answers and the application 2314 requirements, the user may be directed back to the beginning of the compliance requirement 2302 2304 2308 process.

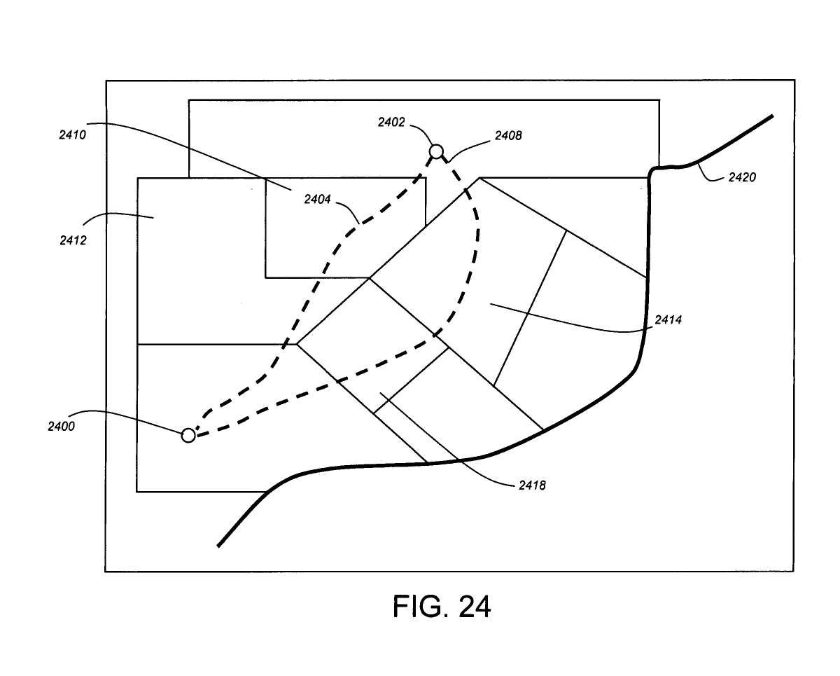

Referring to FIG. 24, a method of determining land values based on a pathway determination is shown. A plurality of pathway determinations 2404 2408 may be determined between a starting point 2400 and an ending point 2402. In an embodiment, property values may be applied to a path determination depending on construction needs, constraints, environmental considerations, political considerations, or the need to avoid certain properties. These property values may be a determining factor in the path selection or may be used to present to a community the cost to avoid certain properties.

In an embodiment, a first path determination 2404 may start from the start point 2400, cross a first property 2412, cross a second property 2410, end at the end point 2408, and have a first value. A second path determination 2408 may start from the start point 2400, cross a first property 2418, cross a second property 2414, end at the end point 2408, and have a second value. The first 2404 and second 2408 path determinations may be determined by the values of the land traversed, construction needs, constraints, environmental considerations, or political considerations. In an embodiment, the two different path determination values may be used as a factor for a community to choose one path determination over another. A first path determination may be less expensive, but a second path determination may avoid certain sensitive properties. In an embodiment, a community may choose a more expensive path determination to satisfy protecting a valuable property.

In an embodiment the value of land 2410 2412 crossed by path determination 2404 is calculated by the difference between the project cost of 2404 and 2408, or the extra cost incurred if the project cannot go through the properties 2410 and 2412.

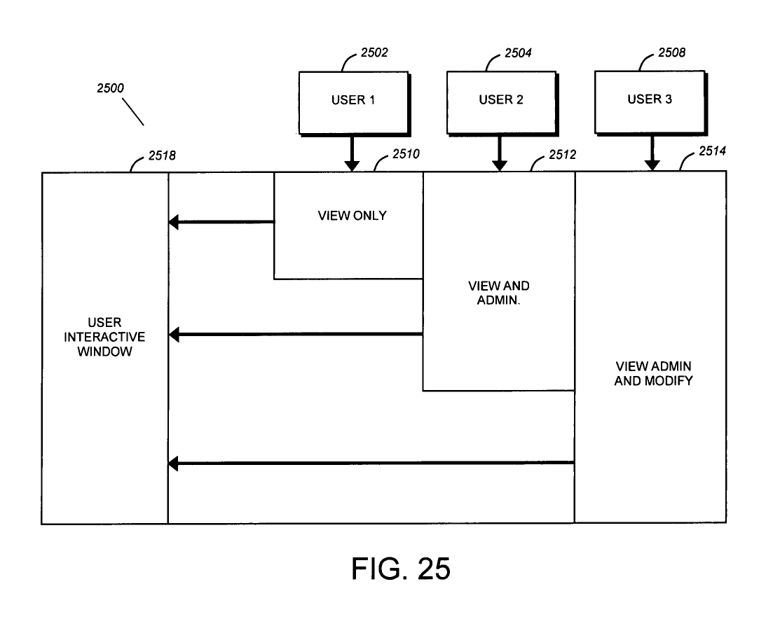

Referring to FIG. 25, a high level schematic of user access to an application with user collaboration is shown. A plurality of users 2502 2504 2508 may have access to an application 2500 that may act on a project model, database, or file. Users 2502 2504 2508 may have different access levels 2510 2512 2514 to the application 2500 based on an encryption key as described in FIG. 22. The users 2502 2504 2508 may be able to collaborate on a project by use of a user interactive window 2518 that may allow a user to store images, text files, comments, or be part of a live chat room environment. Access to the user interactive window 2518 may be available regardless of the users' 2502 2504 2508 permission level 2510 2512 2514.

In an embodiment, user 1 2502 may have view-only access 2510 to the application 2500 that may allow the user 1 2502 to review but not modify a project model, database, or file. User 2 2504 may have view and administration access 2512 that may allow viewing and report creation of the project model, database, or file. User 3 2508 may have full access 2514 to the application 2500 and the project model, database, or file. In an embodiment, all three users 2502 2504 2508 may be able to have access to the user interactive window 2518. In an embodiment, the users 2502 2504 2508 may be able to store information such as images, text files, or comments that may be of interest to the project model, database, or file. The user interactive window 2518 may allow collaboration between a user 2502 with minimal privileges and a user 2508 with full privileges to the application 2500. In an embodiment, the users 2502 2504 2508 may be able to participate in a live chat window to exchange ideas on a project model, database, or file.

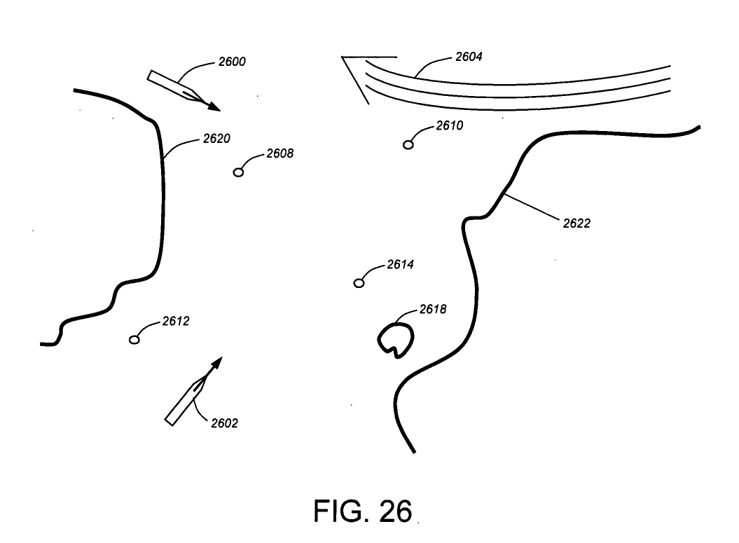

Referring to FIG. 26, a method of navigating a transportation facility in a corridor is shown. A navigation system may be used by a transportation facility 2600 that is capable of path determination to compensate for fixed constraints, effects of the environment, and avoidance of another transportation facility 2602. The path determination may be optimized for fuel consumption and time of passage and may continually update the path determination based on the changing conditions of the environment being traversed.

In an embodiment, a water transportation facility 2600 may wish to traverse a channel as defined by markers 2608 2610 2612 2614. There may be currents 2604 that may be influenced by the landmasses 2620 and 2622. As the water transportation facility 2600 approaches the markers 2608 and 2610, the navigation system may be able to measure the current 2604 and compensate to approach the channel in the proper manner and remain on the path determination. Once in the channel, the water based transportation facility 2600 may continue to measure channel currents and channel winds and create new path determinations to remain in the proper location in the channel to minimize fuel consumption and/or time of passage.

In an embodiment, a second water transportation facility 2602 may be exiting the channel as the first water transportation facility 2600 may be entering the channel. The water transportation facility 2600 may provide a safe path determination with the second water transportation facility 2602. The path determination may continually update the path determination based on the movements of the second water transportation facility 2602, water currents, and wind currents.

In an embodiment, safe path determinations may be created that provide a safe zone of passage to fixed constraints such as land 2620 2622, islands 2618, and markers 2608 2610 2612 2614.

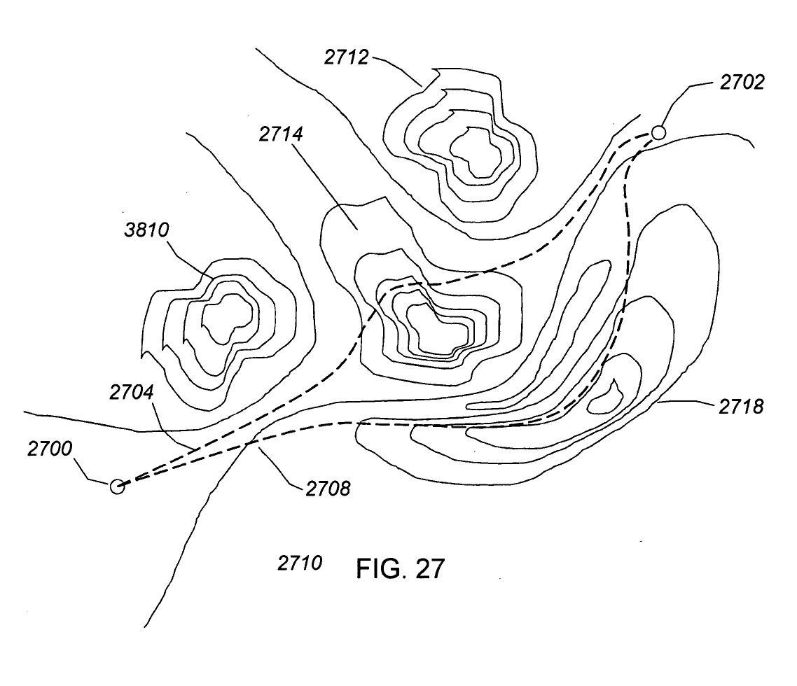

Referring to FIG. 27, path determination over terrain in real time is shown. In an embodiment, a plurality of path determinations 2704 2708 may be created in real time for an all-terrain vehicle (ATV) traversing terrain that does not have roads. In an embodiment, path determinations may be created from a start point 2700 to an end point 2702 with consideration of terrain, roads/paths, streams, and avoidance zones. In embodiments, the path determination may be created in real time as the vehicle is in motion, with new path determinations created based on the current location of the vehicle. The path determination may consider line of sight and the terrain topography.

In an embodiment, a vehicle may start from a start point 2700 and set an end point 1702. In an embodiment, two path determinations 2704 2708 may be presented to the vehicle based on the topography of the local terrain 2710 2712 2714 2718 and the safe capabilities of the vehicle. In an embodiment, the vehicle may start on a first path 2704 that may traverse a hill 2714 to the north, maintaining a change in elevation that provides for safe passage. In an embodiment, as the vehicle deviates from the path determination 2704, a new path determination may be generated to the end point 2702.

In an embodiment, path determinations may be created that provide for fuel efficiency, shortest time, or safest route. In an embodiment, a user may choose one of the path determinations, and the path determination may be continually updated based on position on the chosen path.

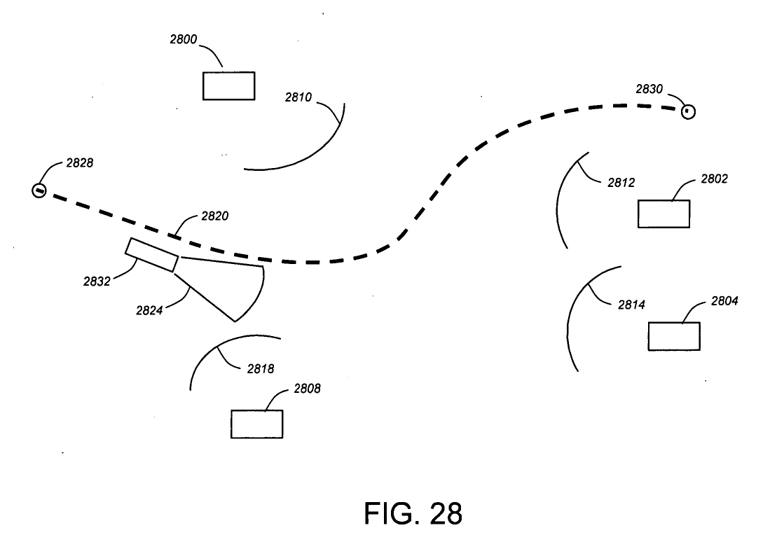

Referring to FIG. 28 a method of path determination considering line of sight is shown. A path determination 2820 may need to be planned between two points that considers maintaining a distance from structures 2800 2802 2804 2808 to provide either a safe distance or to reduce line of sight aesthetic impact upon the structures 2800 2802 2804 2808 in the path determination. The maintained zone distance 2810 2812 2814 2818 from structures may be for safety reasons such as hazardous material movement on the path determination, transportation in a hazardous environment, an aesthetic distance from structures, avoidance of sun glare in the morning or dusk, or to minimize the vehicle 2822 headlight 2824 glare on another vehicle or structure 2800 2802 2804 2808. For each structure along a path determination, a zone distance 2810 2812 2814 2818 may be established that defines the minimum approach distance to the structure 2800 2802 2804 2808. The zone distances 2810 2812 2814 2818 may be maintained in a database or file and may be accessed when the path determination 2820 is created.

In an embodiment, a path determination 2820 may be created from a start point 2828 to an end point 2830. There may be structures 2800 2802 2804 2808 between the start point 2828 and end point 2830 that may have defined zones 2810 2812 2814 2818. In an embodiment, the path determination 2820 may be optimized for a vehicle 2822 to travel on the path determination 2820 with the reach of its headlights 2824 outside of the defined zones 2810 2812 2814 2818. In an embodiment, this may be a line of sight consideration for the structures 2800 2802 2804 2808.

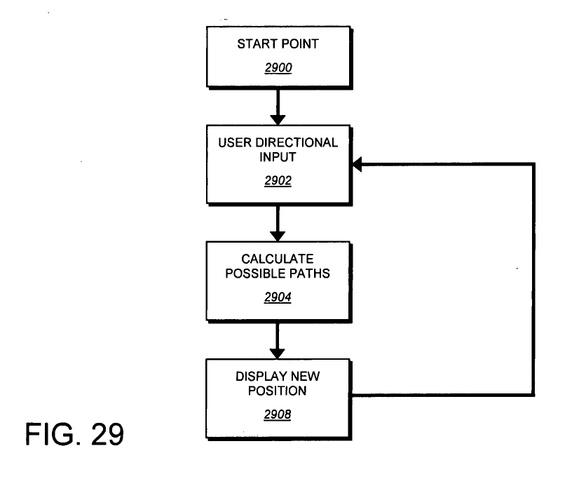

Referring to FIG. 29, a high level flow chart for real time virtual path creation is shown. Virtual path determination may be used in electronic simulations that may provide real time user input and may require new path determinations to be created. The electronic simulation may define constraints that the path determination may need to avoid.

In an embodiment, a start point 2900 may be predefined or may be assumed to be the current location of the virtual user. There may be a predefined end point as a destination, or a path determination may be created based on a predefined set of rules for traversing an electronic topography. The start point 2900 may be anywhere on an electronic simulation defined by a model, database, or file. The simulation may allow for a user to provide directional input 2902 from the start point 2900. The directional input 2902 from a user may be on the previously defined path determination or the user may deviate from the defined path determination.

In an embodiment, if the user deviates from the defined path determination, a plurality of new possible path 2904 determinations may be created to either get to a defined end point or follow a set of topography traverse rules. As part of the calculation of possible paths 2904 step, the electronic simulation may select a best path determination to present to the user.

In an embodiment, once a path determination is selected the electronic simulation may display the new position 2908 on the selected path determination. In an embodiment, with the new position displayed 2908 to the user, the sequence is started over with the user directional input 2902 in relation to the new path determination.

In an embodiment, the sequence may be repeated until the electronic simulation determines that a final destination has been achieved.

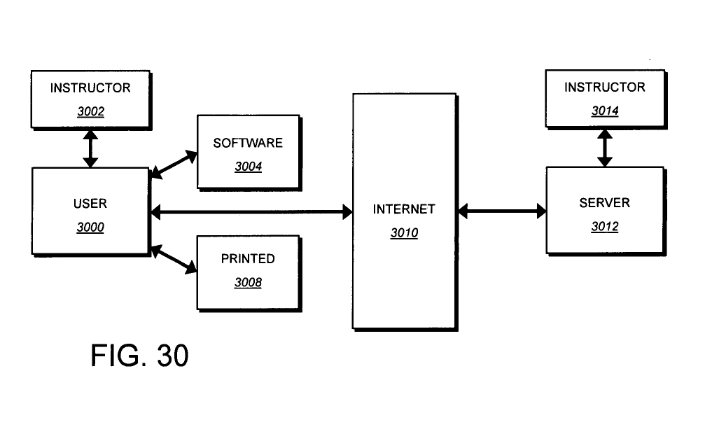

Referring to FIG. 30, a high level schematic of providing materials for path determination training is shown. A user 3000 may require training to optimize a path determination based on an optimization facility that considers a large number of possible path determinations. A user 3000 may be trained to relax a constraint in order to determine the effect of the constraint, select constraints based on the requirements of a particular path determination environment, consider input from a collaboration facility in selecting a path, enter variables relating to at least one of a plurality of constraints, or review alignments using at least one of a plurality of views.

In an embodiment, an instructor 3002 in a classroom may train a user 3000; the instructor 3002 may use software 3004 or printed text 3008 to aid in the training. In an embodiment, a user 3000 may be provided with self-guided software 3004 or printed text 3008 that does not require an instructor 3002 to train the user 3000.

In an embodiment, an instructor 3014 may provide training over an internet connection 3010. The user may connect to a training server 3012 by accessing the internet 3010. This connection to the training server 3012 may allow an instructor 3014 to communicate interactively with a user 3000 for training. In an embodiment, using the internet method of training, a plurality of users 3000 may be trained by an instructor 3014 in a virtual classroom.

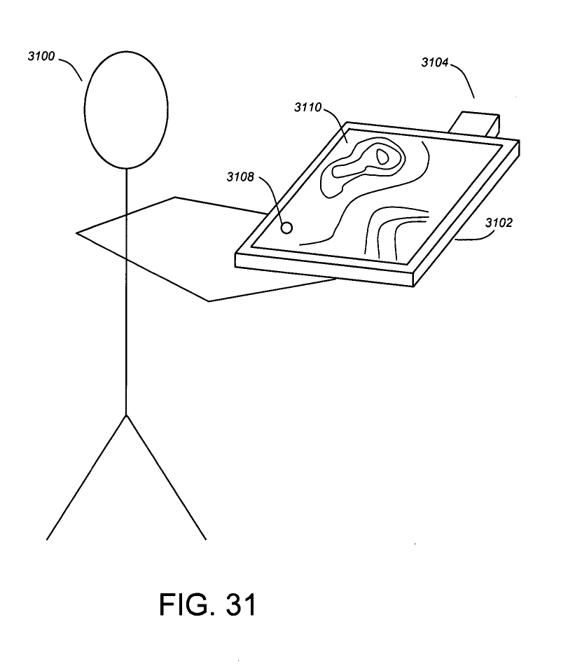

Referring to FIG. 31, remote path determination planning is shown. A path determination client application 3110 may be accessed on a portable computer device 3102. A user 3100 may be able to access path determination models 3110 remotely on the portable computer device 3102 and may be able to interact with the path determination model 3110.

In an embodiment, the portable computer device 3102 may have a location facility 3104 that may determine the location 3108 of the user 3100 on the path determination model 3110. In an embodiment, as a user 3100 moves in the area defined by the path determination model 3110 the location 3108 may be updated and displayed. In an embodiment, the user 3100 may be able to view the path determination model 3110 and move to a place of interest as displayed on the portable computer device 3102.

In an embodiment, a user 3100 may be able to define an area of constraint by using the location facility 3104 to indicate a location 3108 on the path determination model 3110. The user 3100 may traverse around a zone to be defined. As the zone area is traversed, the user may be able to indicate the perimeter of the zone using the location 3108. The defined zone may then be entered into the path determination model. In an embodiment, a new path determination may be created based on the newly defined zone.

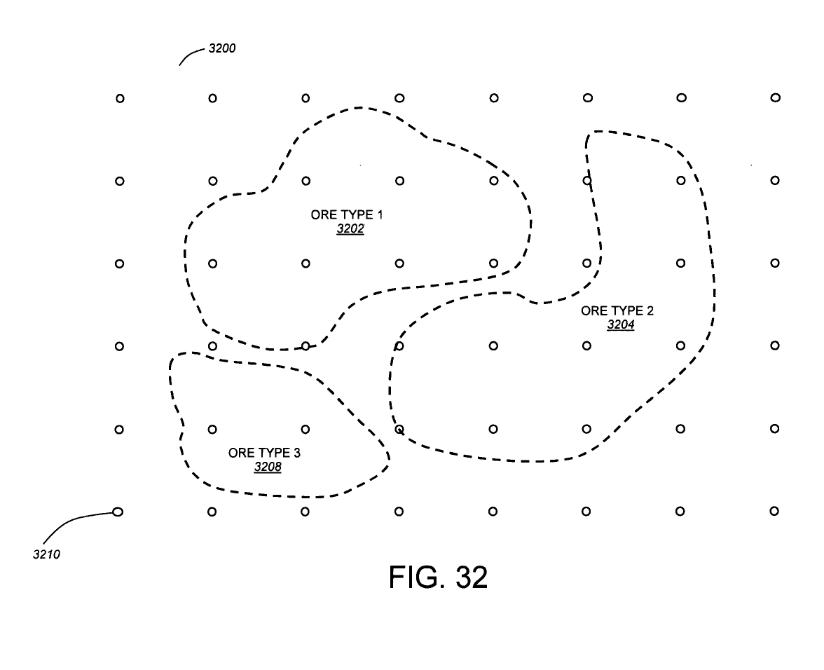

Referring to FIG. 32, a schematic of open mine extraction development is shown. An open mine area 3200 may contain a plurality of ore types 3202 3204 3208. The mineral may be an ore, a metal, a gemstone, or coal. The development of an open mine 3200 may involve determining the location of the ore 3202 3204 3208 and the quantity of each of the ores. The ore type and location may be determined by taking core samples 3210 as a grid and then mapping the ore types 3202 3204 3208 in the open mine 3200 area.

In an embodiment, scheduling mineral extraction of the plurality of ores 3202 3204 3208 may be done with a planning tool with consideration of mineral market values and extraction costs. Over the life of the open mine 3200, the different types of ore 3202 3204 3208 may have varying values on the exchanges where the ores 3202 3204 3208 are sold. In an embodiment, ore type 1 3202 may be extracted first, but if its value on the exchange falls below either ore type 2 3204 or ore type 3 3208, extraction may be changed to ore type 2 3204 or ore type 3 3208 to take advantage of the better value.

In an embodiment, planning mineral extraction with the planning tool may account for available machinery capability and efficiency. In an embodiment, even if the exchange value of an ore were to decrease in relation to the other available ores, it may still be more profitable to continue to mine the ore because of favorable extraction rates.

In an embodiment, a planning tool may calculate a profit considering the exchange value of the ore and the extraction cost. In an embodiment, the ore with the greatest profit may be mined until the profit of a different ore is determined to be greater.

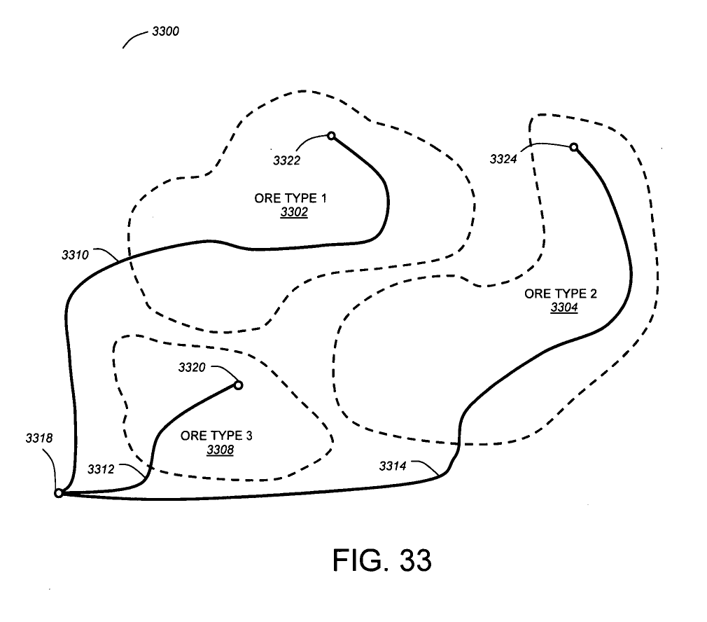

Referring to FIG. 33, a schematic of underground mine path determination is shown. An underground mine 3300 may contain a plurality of different ore types 3302 3304 3308 that may require path determinations for access with machinery and for material extraction. A start point 3318 and an end point 3320 3322 3324 for each of the ore types 3302 3304 3308 may be defined. The start point 3318 may be a common or different location for each type of ore 3302 3304 3308. At least one path determination 3310 3312 3314 for each ore type may be created and may consider route length, location, machinery type in use, and method of construction. A path determination 3310 3312 3314 may be selected that provides the best access to the ore types 3302 3304 3308.

The path determination may use underground mineral location and quantity to determine the selection and order of underground access options. The order in which the ore 3302 3304 3308 is extracted may be determined by mineral location and quantity, direct cost of extraction, and value of the extracted ore, and the cost and return analysis may be compared for each of the plurality of routes. In an embodiment, the ore type 3302 3304 3308 that is extracted may be based on the profit margin of these factors. A mining operation may switch from one ore to another ore based on the calculated profit margin.

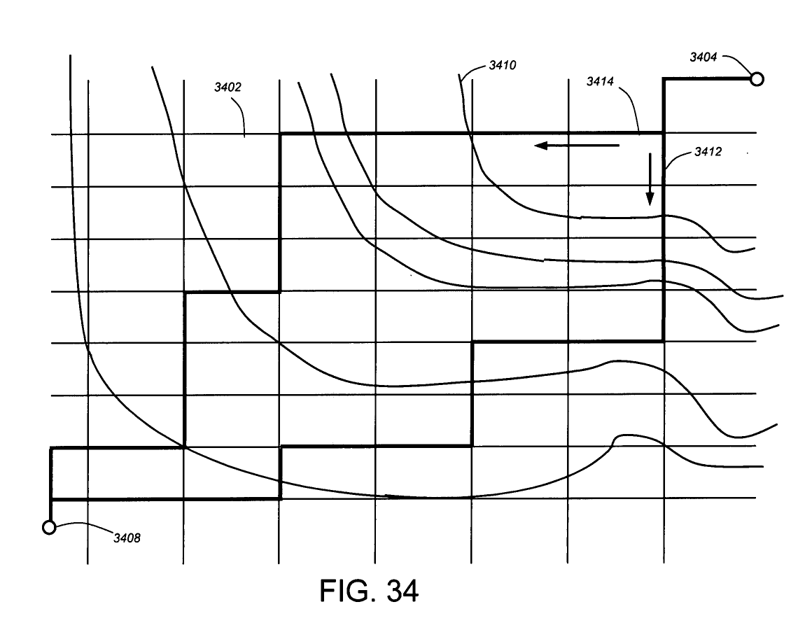

Referring to FIG. 34, a schematic of fluid flow control is shown. Path determinations may be made to control fluids within a community 3402 in order to control the flow from a start point 3404 to an end point 3408. A plurality of path determinations 3412 3414 may be created for possible paths from the start point 3404 to the end point 3408. The path determinations may be based on constraints that may be selected from the group consisting of topography, a composition of materials, a political constraint, an environmental constraint, a temperature constraint, a fluid flow rate, a demand-based constraint, a water-supply-based constraint, an agricultural constraint, and a user-defined constraint.

In an embodiment, the path determination may be restricted to the community 3402 street layout and may have to follow existing roads. Depending on the fluid to be directed, a path determination 3412 may follow the topography 3410 with a steeper terrain. This path determination may take advantage of the steep grade that may not require a pumping station to move the fluid.

In an embodiment, a second path determination 3414 may follow a topography 3410 with a more gradual slope that may control the fluid flow more properly but may require a pumping station because of the more gradual terrain.

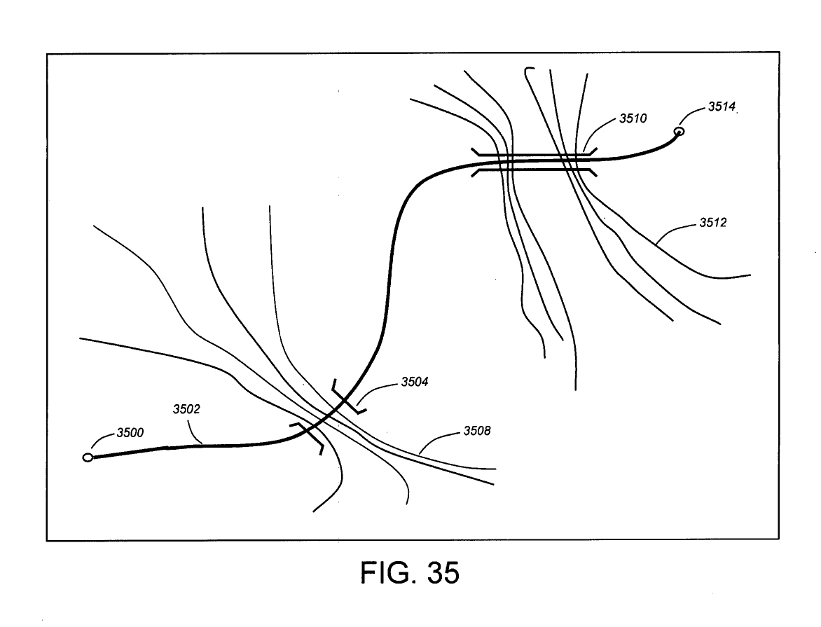

Referring to FIG. 35, a schematic for predicting ground water flow and path determination is shown.

Digital terrain mapping (DTM) is a digital representation of the topography of a region.

DTM may be used to predict ground water flow in a region and may be used by a path determination application for the selection of a path to use a culvert or bridge, or to avoid ground water.

In an embodiment, a path determination 3502 may be between a start point 3500 and an end point 3514. There may be a plurality of topography features 3508 3512 that the path determination 3502 needs to traverse. Using the DTM to determine the topography 3508 3512, steepness, and possible ground water flow, the path determination application may be able to select either a bridge 3504 or culvert 3510 to be used to cross the ground water.

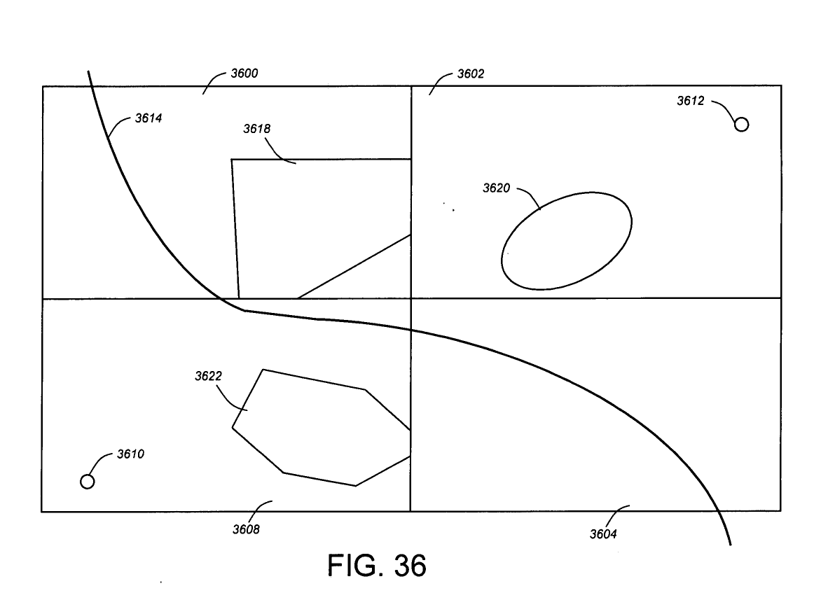

Referring to FIG. 36, a schematic of ground water mapping for path determination is shown. A path determination may need to cross a region that may contain a plurality of different water flow or ground water zones as constraints to the path determination. A region may contain a river 3614, a lake 3618, a swamp 3622, or wet land 3620 that may require a bridge, culvert, or a path to avoid the zone. In an embodiment culvert zones may be defined for crossing flood plains or areas that experience sheet water flows where a minimum number of culverts per distance may be required.

In an embodiment, a path determination may have a starting point 3610 and a finish point 3612. A plurality of path determinations may be created with consideration of the rules of the ground water constraints.

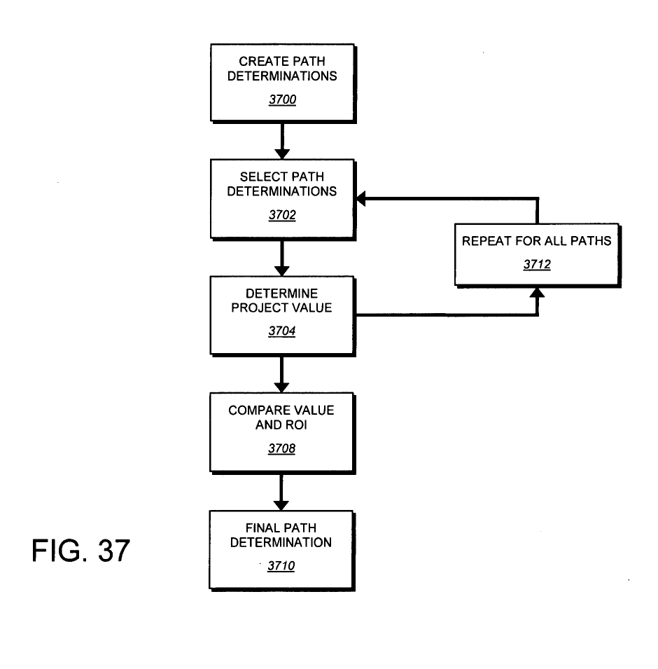

Referring to FIG. 37, a high level flow chart of project cost modeling is shown. The process of developing a cost model may result in a project return on investment (ROI) that may be a significant part of a path determination. A plurality of path determinations may be created 3700 between two points.

In an embodiment, a sequence to review all of the path determinations may be performed. A first path determination may be selected 3702 and a determination of the project value 3704 may be calculated. This process may be repeated for all paths 3712 by selecting the next path determination 3702 and calculating the project value 3704. Along with the project value, a project ROI may be calculated based on rules for the path determination project.

In an embodiment, all of the calculated values and ROI may be compared 3708 and a ranking of the path determinations may be created. Based on the path determination project ranking, a path determination project may be selected and the final path determined 3710. In an embodiment, the path determination project with the best value and ROI may not be the path determination selected. The values and ROI among the path determinations may be similar, and other considerations may be combined with the project value and ROI for the selection of the final path determination 3710.

In an embodiment, the system may be linked with finance models or financial modeling software that utilizes cost and alignment data from the system to determine whole-of-project costs, including operation and maintenance. Data or output from financial models could also be input into the system to investigate the impact of ‘what-if’ scenarios that may increase project construction cost and thus reduce the whole of project cost.

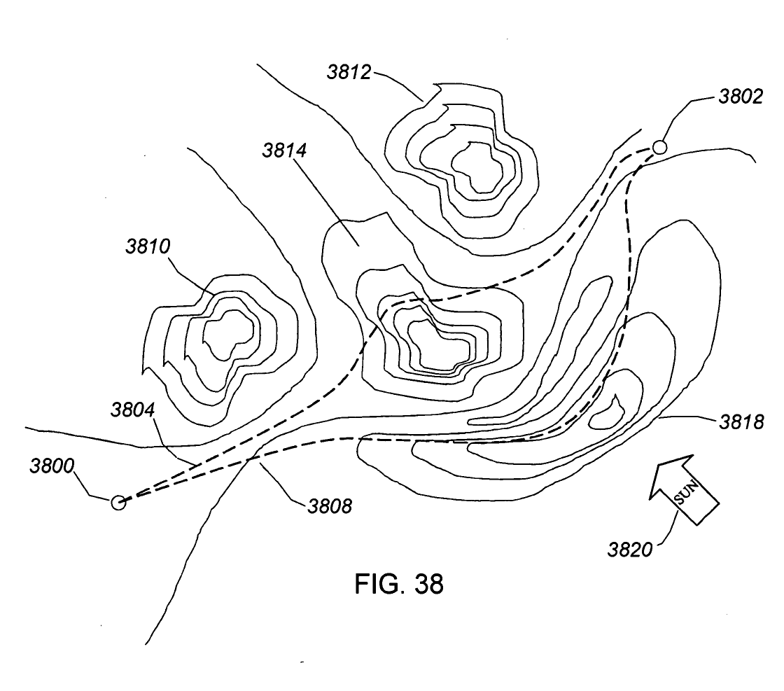

Referring to FIG. 38, a schematic of non-terrestrial path determination is shown. Path determinations may be created for non-terrestrial locations with consideration to special constraints of the non-terrestrial location. Constraints may be selected from a group consisting of a gravitational constraint, a non-terrestrial material constraint, an extraction cost constraint, an equipment cost constraint, an equipment transportation constraint, a fuel-based constraint, a sun and shadow constraint, and an environmental impact constraint.

In an embodiment, path determinations may be made on a reduced gravity non-terrestrial location that may be either a hot or cold environment. Path determinations may be made from a starting point 3800 to an ending point 3802. The region to be transited may contain various topographical areas 3810 3812 3814 3818 that may either be mountains or depressions.

In an embodiment, in a hot environment with exposure to the sun 3820 it may be advantageous to have a path determination 3808 that is in shadow as often as possible. In a location with reduced gravity, the path determination may climb up a slope 3818 in order to stay in the shadow of the mountain for as long a time as possible to reduce the need to cool the transportation facility in use.

In an embodiment, in a cold environment with exposure to the sun 3820 it may be advantageous to have a path determination 3804 that is in the sun as often as possible. In a location with reduced gravity, it may not matter if the topographical area 3814 is a mountain or depression because moving up and down a slope will require less energy. In an embodiment, path determination 3804 may provide the most sun exposure in a cold environment and may reduce the need to heat the transportation facility in use.

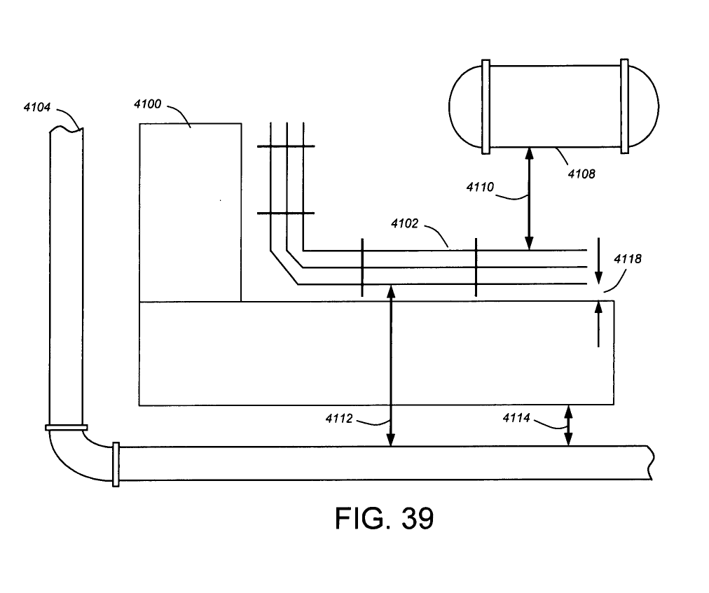

Referring to FIG. 41, a schematic for determining a layout of facility conduit is shown. In the layout of a facility there are often safety requirements for the placement of a conduit in proximity to other features of the facility. The constraints may be selected from a group consisting of a safety constraint, a required spacing from another item, a service requirement for a service delivered via the conduit, a material requirement for a material delivered via the conduit, a cost of conduit material, and a loss parameter for loss of power or flow based on distance traveled via the conduit.

A conduit may be for carrying electrical energy or carrying fluids. The safe distance values may be stored in a database or file and the path determination may access the database or file. The conduit may be a conduit for heat, ventilation, cooling, water, wastewater, a network, or electricity, or the conduit may carry chemicals required for or arising from a manufacturing process.

In an embodiment, path determinations may need to be made for power lines 4102 and a fluid pipe 4104. The area may have two constraints, a storage tank 4108 and a pedestrian walkway 4100. In an embodiment, there may be a storage tank 4108 safe distance 4110, a walkway safe distance 4118 4114, and a safe distance 4112 between the power lines 4102 and the fluid pipe 4104.

In an embodiment, a path determination application may be able to create a plurality of path determinations for the power lines conduit 4102 and fluid pipe conduit 4104 with the constraints of the storage tank 4108 and walkway 4100. The path determinations may be automatically optimized for a preferred location. The path determination application may also have to consider safe distance requirements and proper orientation of the conduits.

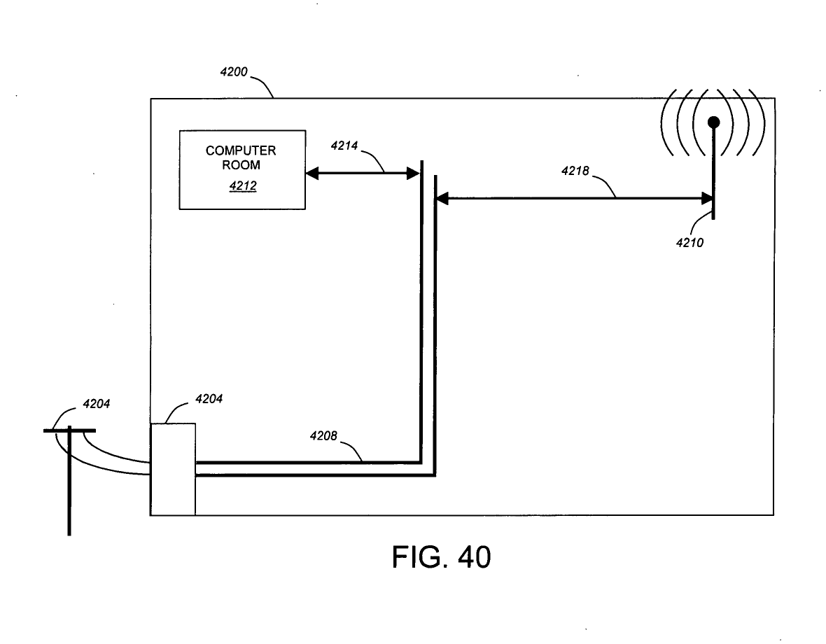

Referring to FIG. 42, a schematic for network planning is shown. In the layout of a facility there are often requirements for the placement of wiring to prevent interference in features sensitive to interference. A path determination application may be capable of creating a plurality of wiring configurations for a facility. Various features in the facility may be sensitive to electromagnetic energy and may have constraint settings applied for minimum distances to prevent interference. The interference settings may be stored in a model, database, or file and accessed by the path determination application. The constraint settings may be selected from the group consisting of an interference distance, the size of an electromagnetic field, a regulatory requirement, a heat-sensitivity requirement, a ventilation requirement, an access requirement, and a load requirement.

In an embodiment, existing features of a facility 4200 may have constraint settings to prevent interference from electromagnetic sources. A facility 4200 may wish to run a new set of power lines 4208 into the facility 4200. The facility 4200 may have an existing computer room 4212 and transmission tower 4210. The power lines 4208 may receive power from an outside source 4202 accessed through a power junction 4204.

In an embodiment, the path determination application may create a plurality of possible path determinations for the power lines 4208 to maintain the computer room safe distance 4214 and the transmission tower safe distance 4218. The path determination application may optimize the path determinations of the wire network so a final path determination may be selected.

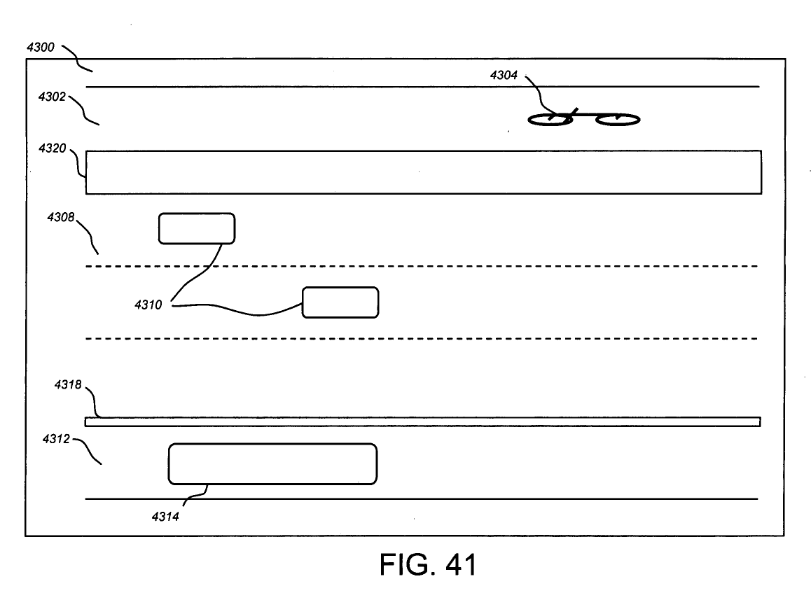

Referring to FIG. 43, a schematic for planning restricted lane pathways is shown. In many pathway settings, there is a need for restricted lanes for specialized vehicles. It often aids the movement of passenger vehicles if vehicles such as buses and trucks can have separate travel lanes. In urban areas there may also be a need to have pathways for pedestrians and bicycles that may be separate from the heavier and faster vehicles. The separations of these different vehicle types may require different separation distances and barriers. In addition, these different pathways often need to fit into a restricted space.

A path determination application may be able to create a plurality of path determinations for the various travel requirements and maintain safe distances and barriers.

In an embodiment, an area 4300 may require that there be a bus lane 4312, auto lanes 4308, and a bicycle lane 4302. The separation and barrier type may be stored in a model, database, or file and accessed by the path determination application. In an embodiment there may be a required distance between the light bicycle 4304 and the heavier car 4310 that may require a grass and fence separation 4320. The separation between the much heavier bus 4314 and the heavy car 4310 may need to be a cement barrier to contain any potential accidents.

In an embodiment, the path determination application may be able to create the path determinations for the multiple vehicle requirements. The multiple paths may run parallel in a single corridor or follow separate routes dependent on constraints of community, environment, terrain, and cost. The path determinations may be optimized to allow for a final path determination selection.

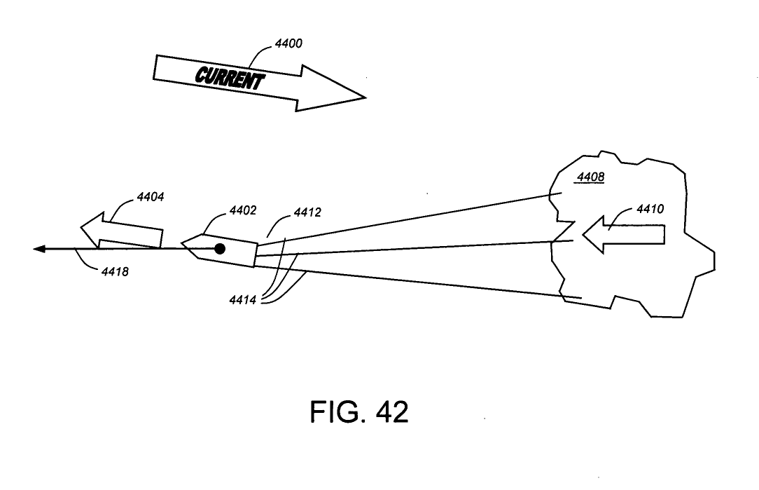

Referring to FIG. 44, a schematic of iceberg farming is shown. Iceberg farming may require determining the current location of an iceberg and collecting data relating to constraints and influences on speed and direction of natural flow between the iceberg and a final location. The constraints and influences may be selected from the group consisting of water temperatures, currents, permitted navigation routes, safety of navigation routes, fuel consumption, air temperatures, humidity, cloud cover, sunlight, wave height, wave direction, rates of melting, iceberg size, iceberg composition, wind direction, wind speed, weather, and political constraints.

A model may be created for the path from the current location of the iceberg to the final location with the model taking into account the constraints. A path determination application may use the model to create a large number of possible paths. Once the possible path determinations are created, a preferred path from farming location to delivery may be selected based on the optimization of the path determination using the constraints and influences.

In an embodiment, in moving an iceberg 4408 from a starting location, a ship 4402 may need to navigate the iceberg 4408 through natural currents 4400. A path determination may be continually updated to account for the current 4400, water temperature, air temperature, fuel consumption, and time required to transport. To follow the selected path determination it may be necessary to move the ship along a vector 4418 and the iceberg along a vector 4410. Vectors 4418 and 4410 may be in the same direction. The path determination may be able to provide input to the navigation system of the ship 4402 to determine that a vector 4404 needs to be steered to maintain a vector 4418 4410 into the current 4400.

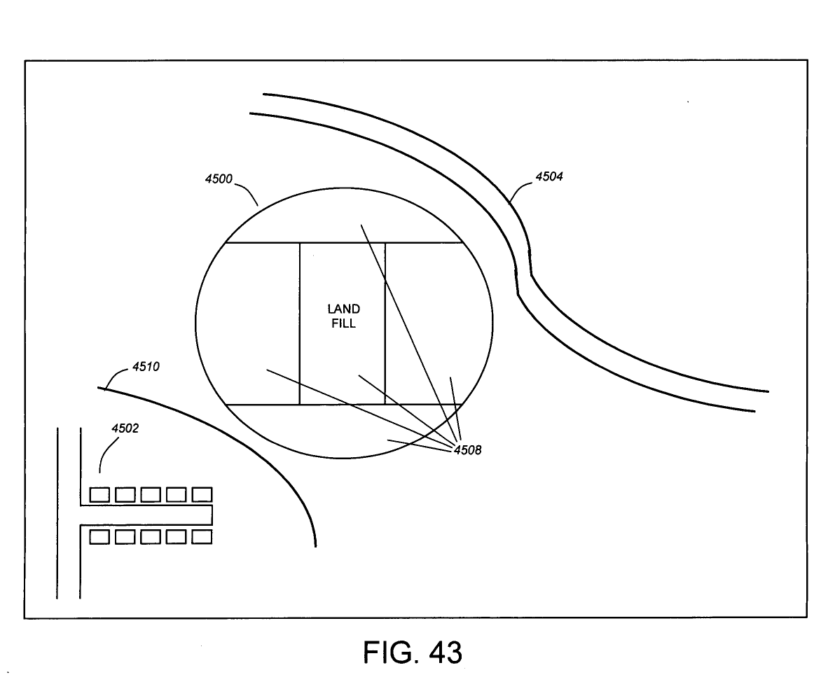

Referring to FIG. 45, the schematic of a landfill management is shown. The creation of landfills may require that certain materials be separated by safe distances to prevent inadvertent reactions among those materials. A model may be created of location parameters for a separation requirement of a plurality of materials. The model may also define a zone with separation parameters for local environmental features and structures. An application may be used in selecting the locations for a plurality of landfill materials in accordance with separation parameters.

In an embodiment, a landfill 4500 may be created that contains a plurality of materials 4508. There may be separation parameters for each of the materials 4508 in the landfill 4500.

In an embodiment, there may be environmental features and structures that must maintain separation parameters from the landfill 4500. A river 4504 may require the landfill be a safe distance away 4500 to prevent runoff into the river 4504. A housing development 4502 may have a defined separation distance 4510 from a landfill to prevent the landfill from polluting the underground aquifer from which the housing development wells draw.

While the invention has been disclosed in connection with certain preferred embodiments, other embodiments will be understood by those of ordinary skill in the art and are encompassed herein.

1. A method for identifying alternative paths for projects, comprising:
providing a client-based application having a GUI that presents a plurality of constraints that relate to a project;
providing a server-based application for calculating the costs of a plurality of potential paths for presenting a subset of paths with associated cost data; and
determining optimized paths for at least one of a pipeline, a conveyor, a canal, a multipurpose utility pipe, and a telecommunication line.

2. The method of claim 1 further comprising providing at least one of a constraint and a factor specific to the pipeline.

3. The method of claim 2, wherein the pipeline constraints are at least one of cross slope or long slope dependent costs, ability to and cost of ascending after ‘low points’, and necessity and parameters for pumping stations.

4. (canceled)

5. The method of claim 1 further comprising providing constraints specific to the conveyors.

6. The method of claim 5, wherein conveyor constraints are at least one of varying geometry along their length, limitations of curve, grade, and crests and sags to maintain belt tension.

7. The method of claim 1 further comprising providing constraints specific to the canal.

8. The method of claim 7, wherein the canal's constraints are at least one of maximum or minimum allowable ‘head of water’, whether locations of locks or hydro power facilities are fixed or can be moved, and groundwater levels and lining cost impact of going through zones below groundwater level.

9. The method of claim 1 further comprising providing constraints specific to at least one of the multipurpose utility pipe and power line.

10. The method of claim 9, wherein the constraints are at least one of a safety constraint, a required spacing from another item, a service requirement for a service delivered via the conduit, a material requirement for a material delivered via the conduit, a cost of conduit material, and a loss parameter for loss of power or flow based on distance traveled via the conduit.

11. (canceled)

12. The method of claim 2, wherein the telecommunication line is at least one of a telephone line, DSL line, TV cable line, copper wire, coax cable, fiber optic line, microwave communication facilities, above ground cable, and below ground cable.

13. (canceled)

14. A system for alternative paths for projects, comprising:
a client-based application having a GUI that presents a plurality of constraints that relate to a project; and
a server-based application for calculating the costs of a plurality of potential paths for the projects and presenting a subset of paths with associated cost data; wherein the server-based application is adapted to determine optimized paths for at least one of a pipeline, a conveyor, a canal, a multipurpose utility pipe, and a telecommunication line.

15. The system of claim 14 wherein the server-based application further adapted to consider at least one of a constraint and a factor specific to the pipeline.

16. The system of claim 15, wherein the pipeline constraints are at least one of cross slope or long slope dependent costs, ability to and cost of ascending after ‘low points’, and necessity and parameters for pumping stations.

17. (canceled)

18. The system of claim 14 further comprising providing constraints specific to the conveyors.

19. The system of claim 18, wherein conveyor constraints are at least one of varying geometry along their length, limitations of curve, grade, and crests and sags to maintain belt tension.

20. The system of claim 14 further comprising providing constraints specific to the canal.

21. The system of claim 20, wherein the canal's constraints are at least one of maximum or minimum allowable ‘head of water’, whether locations of locks or hydro power facilities are fixed or can be moved, and groundwater levels and lining cost impact of going through zones below groundwater level.

22. The system of claim 14 further comprising providing constraints specific to at least one of the multipurpose utility pipe and power line.

23. The system of claim 22, wherein the constraints are at least one of a safety constraint, a required spacing from another item, a service requirement for a service delivered via the conduit, a material requirement for a material delivered via the conduit, a cost of conduit material, and a loss parameter for loss of power or flow based on distance traveled via the conduit.

24. (canceled)

25. The system of claim 14, wherein the telecommunication line is at least one of a telephone line, DSL line, TV cable line, copper wire, coax cable, fiber optic line, microwave communication facilities, above ground cable, and below ground cable.

26. (canceled)
